(19) United States
(12) Patent Application Publication
(10) Pub. No.: US 2023/0216590 A1
(43) Pub. Date: Jul. 6, 2023

(54) Dynamically-Switchable Optical Cable

(71) Applicant: WINGCOMM CO. LTD., Nantong (CN)

(72) Inventors: Jianming Yu, Nantong (CN); Zuodong Wang, Beijing (CN); Wei Mao, Palo Alto, CA (US); Yun Bai, Beijing (CN)

(21) Appl. No.: 17/970,219

(22) Filed: Oct. 20, 2022

(30) Foreign Application Priority Data
Dec. 31, 2021 (CN) 202111675460.0

(51) Int. Cl. H04B 10/25

(52) U.S. Cl. CPC H04B 10/2589

(57) ABSTRACT

Dynamically-switchable optical cables are described. One aspect includes a first terminal and a second terminal, each including a USB/Thunderbolt high-speed electrical interface. Each terminal may include a USB/Thunderbolt signal analysis unit configured to receive one or more USB/Thunderbolt low-speed signals, analyze the USB/Thunderbolt low-speed signals, and determine if the associated terminal is connected to one of a USB/Thunderbolt signal source or a USB/Thunderbolt signal sink. Each terminal may include a signal transmitting unit electrically connected to the respective USB/Thunderbolt high-speed electrical interface, and a signal receiving unit electrically connected to the respective USB/Thunderbolt high-speed electrical interface. The optical cable may include a first optical communication channel connecting an output of the first signal transmitting unit to an input of the second signal receiving unit, and a second optical communication channel connecting an output of the second signal transmitting unit to an input of the first signal receiving unit.

### CROSS-REFERENCE TO RELATED APPLICATION

This application claims the priority benefit of Chinese patent application No. 202111675460.0 titled “A high-speed photoelectric transmission system and cable with dynamic change of transmission direction” filed in the China Patent Office on Dec. 31st, 2021, the disclosure of which is incorporated by reference herein in its entirety.

### TECHNICAL FIELD

The present disclosure relates to systems and methods for communicating one or more photoelectric signals using a cable that is dynamically capable of changing a direction of signal transmission.

### BACKGROUND ART

With the continuous development of communication technology, the interface speed of electronic equipment is constantly improving, from kilobits to megabits, to several hundreds of megabits supported per second as data rates, the interface speed of electronic equipment has entered the category of microwave. Correspondingly, the reliable transmission and reception of electronic interface signals faces more and more challenges. At present, the latest interface communication protocols of electronic equipment have reached a speed of 10 megabits per second. Single-channel HDMI 2.1 signals may be transmitted at rates of up to 12 Gbps, and the communication speeds of protocols such as DP 2.0, USB4, Thunderbolt 3 and Thunderbolt 4 have reached 20 Gbps in a single channel. Support for such high data rates necessitates extremely high requirements for the design of associated equipment and cables. One possible solution to support such high data rates is replacing electrically-conductive copper cables with one or more optical fiber channels. Design approaches for the design of optical fiber-based cables are based on optical fiber communication technology. Using optical fiber to transmit high-speed signals reduces the signal attenuation associated with high-speed signal transmission, improves the signal quality, increases the transmission distance of high-speed signals, and reduces the electromagnetic interference caused by the high-speed signals.

At present, the following solutions have emerged for optical fiber transmission of high-speed electrical signals:

1. For video signal transmission protocols such as HDMI, DVI, DisplayPort (DP), etc., many companies have proposed an optical fiber transmission solution of their high-speed signals. Compared with copper wire, an optical fiber active cable provides better signal quality, longer transmission distance, and less electromagnetic radiation. However, compared with copper wire, this solution can typically only transmit signals in one direction, and such a cable includes distinct terminals (i.e., connectors) for the signal source and the display. In such a cable, one connector must be connected to a signal source, and the other connector must be connected to a signal sink. This increases the possibility of wrong insertion in actual use, and increases the risk of cable and equipment damage.

2. For the signal transmission of universal high-speed interfaces such as USB3, USB4, Thunderbolt, and Lightning, some implementations use optical fiber to transmit high-speed electrical signals, which improves the performance of signal transmission. However, due to the unidirectional nature of optical fiber signal transmission, the communication direction cannot be switched after the cable is manufactured, so it cannot support a DP Alt-Mode.

3. For USB protocols below USB 2.0 and other high-speed half-duplex communication protocols, it is difficult to use optical fiber for high-speed signal transmission. At present, implementation is basically limited to protocol conversion, which is costly and complex.

### SUMMARY

Aspects of the invention are directed to systems and methods for implementing a dynamically-switchable optical connector. One method includes a first terminal receiving one or more first low-speed electrical signals from a communication signal source. The first terminal may be transmission direction agnostic relative to the communication signal source. The first terminal may perform a first analysis on the first low-speed electrical signals, and determine the transmission direction based on the first analysis.

A second terminal may receive one or more second low-speed electrical signals from a communication signal sink. The second terminal is reception direction agnostic relative to the communication signal sink. The second terminal may perform a second analysis the second low-speed electrical signals, and determine the reception direction based on the second analysis.

The first terminal may receive one or more transmit high-speed electrical signals from the communication signal source, and convert the transmit high-speed electrical signals into high-speed optical signals. The first terminal may transmit the high-speed optical signals to the second terminal via an optical communication channel.

Aspects also include apparatuses that implement the described methods.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A is a block diagram depicting an embodiment of an optical signal communication interface.

FIG. 1B is a block diagram depicting an embodiment of an optical signal communication interface.

FIG. 2 is a block diagram depicting an embodiment of a terminal interface.

FIG. 3 is a block diagram depicting an embodiment of a terminal interface.

FIG. 4A is a block diagram depicting an embodiment of a signal transmitting unit interface.

FIG. 4B is a block diagram depicting an embodiment of a signal receiving unit interface.

FIG. 5A is a block diagram depicting an embodiment of a signal transmitting unit interface.

FIG. 5B is a block diagram depicting an embodiment of a signal receiving unit interface.

FIG. 5C is a block diagram depicting an embodiment of a signal monitoring unit interface.

FIG. 6A is a block diagram depicting an embodiment of a signal transmitting unit interface.

FIG. 6B is a block diagram depicting an embodiment of a signal receiving unit interface.

FIG. 7A is a block diagram depicting an embodiment of a signal transmitting unit interface.

FIG. 7B is a block diagram depicting an embodiment of a signal receiving unit interface.

FIG. 8A is a block diagram depicting an embodiment of a signal transmitting unit interface.

FIG. 8B is a block diagram depicting an embodiment of a signal receiving unit interface.

FIG. 9A is a block diagram depicting an embodiment of a signal transmitting unit interface.

FIG. 9B is a block diagram depicting an embodiment of a signal receiving unit interface.

FIG. 10 is a block diagram depicting an embodiment of a terminal interface.

FIG. 11 is a block diagram depicting an embodiment of a terminal interface.

FIGS. 12A and 12B are flow diagrams depicting a method to transmit high-speed electrical signals from a communication signal source to a communication signal sink via an optical communication channel.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein address limitations associated with using optical communication channels for transmitting high-speed digital communication signals. In one aspect, a high-speed photoelectric transmission system (also referred to herein as an “optical connector” or an “optical cable”) is capable of dynamically changing the transmission direction associated with one or more electrical communication signals. Such an optical connector may be comprised of two signal transmission connectors (i.e., two terminals) with the same electrical and mechanical design, and oppositely connected. The optical connector may also include an optical fiber group for connecting the two connectors.

In one aspect, each signal transmission connector comprises a high-speed electrical interface, a signal transmitting unit, a signal receiving unit, a low-speed signal interface and a low-speed signal monitoring unit. Each optical fiber group may be comprised of a first optical fiber bundle (i.e., a first optical communication channel) and a second optical fiber bundle (i.e., a second optical communication channel). The first and second optical fiber bundles (or communication channels) may each be a unidirectional communication channel. The first and second fiber bundles (or optical communication channels) may transmit communications in opposite directions.

In one aspect, the signal transmitting unit of the first connector and the signal receiving unit of the second connector are connected through the first optical fiber bundle. The signal transmitting unit of the second connector and the signal receiving unit of the first connector can also be connected through the second optical fiber bundle. In one aspect, the low-speed signal monitoring unit of each connector is used to monitor the associated low-speed signal interface. The transmission mode and transmission direction information of a signal carried in a low-speed signal received at the first terminal or the second terminal may be obtained by the low-speed signal monitoring unit corresponding to that terminal. The corresponding signal transmitting unit and signal receiving unit of the (first or second) terminal are enabled or turned off according to the transmission or reception mode and transmission or reception direction. In this way, the high-speed electrical signal is bidirectionally transmitted in the optical fiber cable composed of two signal transmission connectors and optical fiber groups, and the transmission direction of optical fiber communication can be switched under the condition that the electrical interface is unchanged.

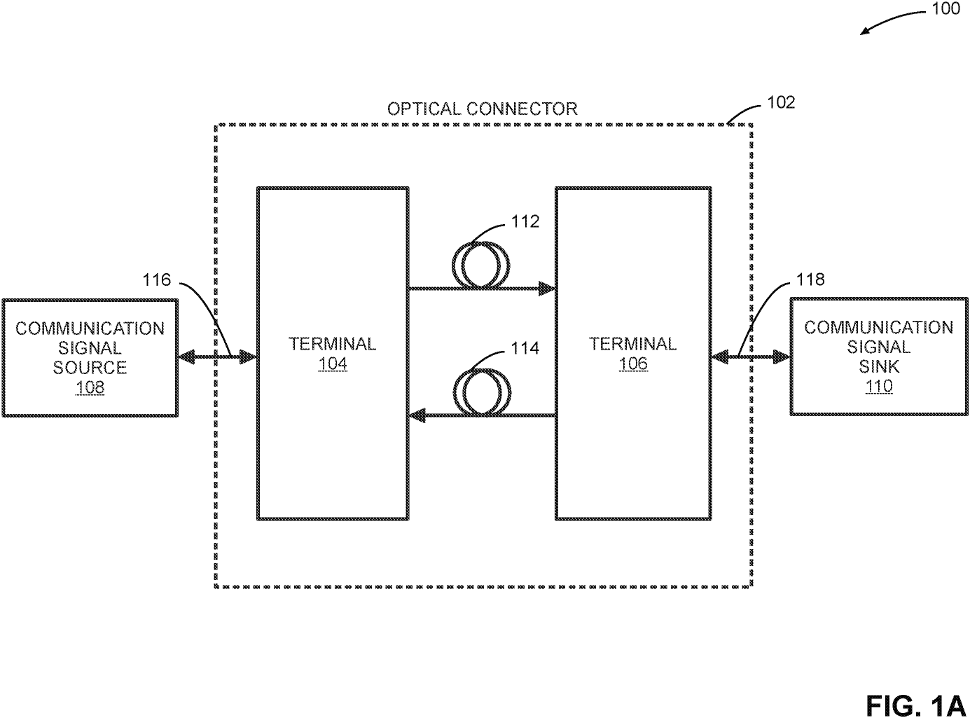

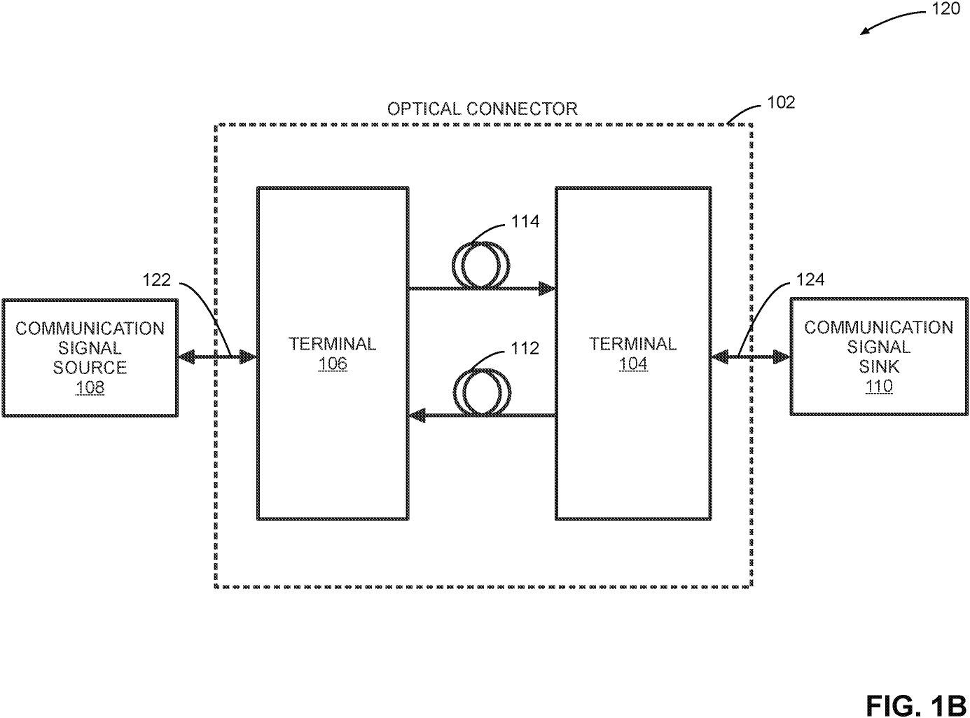

FIG. 1A is a block diagram depicting an embodiment of an optical signal communication interface 100. As depicted, optical signal communication interface 100 includes optical connector 102, communication signal source 108, and communication signal sink 110. Optical connector 102 further includes terminal 104, terminal 106, optical communication channel 112, and optical communication channel 114.

In one aspect, terminal 104 is electrically and mechanically connected to communication signal source 108 via bidirectional electrical communication link 116. Terminal 106 can also be electrically and mechanically connected to communication signal sink 110 via bidirectional electrical communication link 118. In one aspect, optical communication channel 112 is a unidirectional optical communication channel from terminal 104 to terminal 106 and optical communication channel 114 is a unidirectional optical communication channel from terminal 106 to terminal 104. Each of optical communication channel 112 and 114 may each be comprised of one or more optical fibers (e.g., optical fiber bundles). Collectively, optical communication channels 112 and 114 comprise a bidirectional optical communication channel.

In one aspect, each of terminal 104 and terminal 106 may be configured to detect a respective connection to a communication signal source or a communication signal sink. For example, in optical communication interface 100, terminal 104 is connected to communication signal source 108 via bidirectional electrical communication link 116, while terminal 106 is connected to communication signal sink 110 via bidirectional electrical communication link 118.

When terminal 104 is connected to communication signal source 108, terminal 104 may analyze one or more low-speed communication signals received from communication signal source 108 to determine an operating transmission mode. In other words, terminal 104 detects that bidirectional electrical communication link 116 represents an electrical connection to a communication signal source (i.e., communication signal source 108). Terminal 104 may then enable the determined operating transmission mode for one or more high-speed electrical signals received from communication signal source 108.

When terminal 106 is connected to communication signal sink 110, terminal 106 may analyze one or more low-speed communication signals received from communication signal sink 110 to determine an operating reception mode. In other words, terminal 106 detects that bidirectional electrical communication link 118 represents an electrical connection to a communication signal sink (i.e., communication signal sink 110). Terminal 106 may then enable the determined operating reception mode of operation for one or more high-speed signals transmitted by communication signal source 108.

Once terminal 104 and terminal 106 enable the operating transmission and reception modes respectively, terminal 104 may receive one or more high-speed electrical signals from communication signal source 108 via bidirectional electrical communication link 116. Terminal 104 may convert these high-speed electrical signals into high-speed optical signals, and transmit the high-speed optical signals to terminal 106 via optical communication channel 112. Terminal 106 may receive the high-speed optical signals, convert the high-speed optical signals into received high-speed electrical signals (also described as “receive high-speed electrical signals”), and transmit the received high-speed electrical signals to communication signal sink 110 via bidirectional electrical communication link 118.

Optical connector interface 100 is an example of one possible connection of optical connector 102 with communication signal source 108 and communication signal sink 110. In one aspect, optical connector 102 is agnostic to a direction of communication in the sense that terminal 104 can be connected to either a communication signal source or a communication signal sink, with terminal 106 being connected to either a communication signal sink or a communication signal source, respectively. Each of terminal 104 and terminal 106 and communication signal sink include circuitry that analyzes one or more low-speed electrical signals from a respective electrical connection. Responsive to the analysis, each of terminal 104 and terminal 106 determines a connection to a communication signal source or a connection to a communication signal sink. If a terminal is connected to a communication signal source, then that terminal enables a signal transmission mode for one or more high-speed signals. If a terminal is connected to a communication signal sink, then that terminal enables a signal reception mode for the one or more high-speed signals.

FIG. 1B is a block diagram depicting an embodiment of an optical signal communication interface 120. Optical signal communication interface 120 further depicts how optical connector 102 is agnostic to a direction of communication with respect to connectivity. In optical communication interface 120, terminal 106 is connected to communication signal source 108 via bidirectional electrical communication link 122 and terminal 104 is connected to communication signal sink 110 via bidirectional electrical communication link 124. The connection direction of optical connector 102 in FIG. 1B is opposite to the direction of connection of optical connector 102 in FIG. 1A.

When terminal 106 is connected to communication signal source 108, terminal 106 may analyze one or more low-speed communication signals received from communication signal source 108 to determine an operating transmission mode. In other words, terminal 106 detects that bidirectional electrical communication link 122 represents an electrical connection to a communication signal source (i.e., communication signal source 108). Terminal 106 may then enable the determined operating transmission mode for one more high-speed signals.

When terminal 104 is connected to communication signal sink 110, terminal 104 may analyze one or more low-speed communication signals received from communication signal sink 110 to determine an operating reception mode. In other words, terminal 104 detects that bidirectional electrical communication link 124 represents an electrical connection to a communication signal sink (i.e., communication signal sink 110). Terminal 104 may then enable the determined operating reception mode for one or more high-speed signals.

Once terminal 106 and terminal 104 enable the operating transmission and reception modes respectively, terminal 106 may receive one or more high-speed electrical signals from communication signal source 108 via bidirectional electrical communication link 122. Terminal 106 may convert these high-speed electrical signals into high-speed optical signals, and transmit the high-speed optical signals to terminal 104 via optical communication channel 114. Terminal 104 may receive the high-speed optical signals, convert the high-speed optical signals into received high-speed electrical signals, and transmit the received high-speed electrical signals to communication signal sink 110 via bidirectional electrical communication link 124.

Optical signal communication interfaces 100 and 120 represent how optical connector 102 is a dynamically-switchable optical connector that is capable of changing a transmission direction depending on how terminals 104 and 106 are connected to communication signal source 108 and communication signal sink 110.

Examples of communication protocols supported by different embodiments of optical connector 102 include USB/Lightning, HDMI/DVI, DP, and USB 2.0 or a protocol lower than USB 2.0. Optical connector 102 may also be used to implement systems that use half-duplex communication protocols.

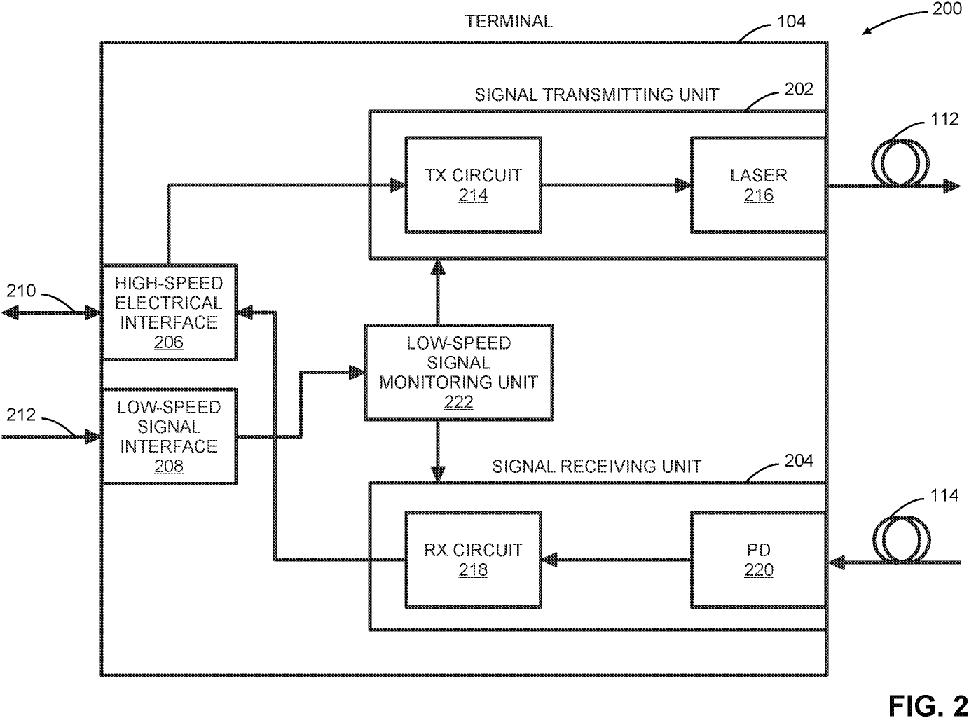

FIG. 2 is a block diagram depicting an embodiment of a terminal interface 200. As depicted, terminal interface 200 includes terminal 104, high-speed electrical communication link 210, low-speed electrical communication link 212, optical communication channel 112, and optical communication channel 114. Terminal 104 further includes high-speed electrical interface 206, low-speed signal interface 208, signal transmitting unit 202, low-speed signal monitoring unit 222, and signal receiving unit 204. Signal transmitting unit 202 further includes transmit (TX) circuit 214 and laser 216. Signal receiving unit 204 further includes receive (RX) circuit 218 and photodetector (PD) 220.

In one aspect, high-speed electrical communication link 210 and low-speed electrical communication link 212 are included in bidirectional communication link 116, for example, if terminal 104 is connected to communication signal source 108. High-speed electrical communication link 210 and low-speed electrical communication link 212 may be included in bidirectional communication link 124, for example, if terminal 104 is connected to communication signal sink 110. In one aspect, high-speed electrical communication link 210 is a bidirectional communication link.

In one aspect, terminal 104 receives one or more low-speed electrical signals from a connected communication signal source (e.g., communication signal source 108) or a communication signal sink (e.g., communication signal sink 110) via low-speed electrical communication link 212. The low-speed electrical signals (also referred to herein as “low-speed signals”) may be transmitted by low-speed signal interface 208 to low-speed signal monitoring unit 222.

In one aspect, low-speed signal monitoring unit 222 analyzes the low-speed signals received from low-speed signal interface 208 to determine whether terminal 104 is connected to communication signal source 108 or to communication signal sink 110. In other words, low-speed signal monitoring unit 222 monitors the low-speed signals received from low-speed signal interface 208.

If terminal 104 is connected to communication signal source 108, then low-speed signal monitoring unit 222 determines that terminal 104 functions as a transmit terminal, in a transmission mode. In this aspect, low-speed signal monitoring unit 222 switches on signal transmitting unit 202 and switches off signal receiving unit 204. In one aspect, a switching on or switching off process for signal transmitting unit 202 or signal transmitting unit 204 is implemented by respectively turning on or turning off respective power supplies to the associated unit. High-speed electrical interface 206 may receive one or more high-speed electrical signals from communication signal source 108. In one aspect, TX circuit 214 receives the high-speed electrical signals via high-speed electrical interface 206. TX circuit 214 may amplify and condition the high-speed electrical signals, and drive laser 216 to convert the high-speed electrical signals into high-speed optical signals. The high-speed optical signals output by laser 216 may be transmitted, for example, to terminal 106 via optical communication channel 112. In one aspect, laser 216 is any of a vertical-cavity surface-emitting laser (VCSEL), a laser diode, or any other kind of laser.

If terminal 104 is connected to communication signal sink 110, then low-speed signal monitoring unit 222 determines that terminal 104 functions as a receive terminal, in a reception mode. In this aspect, low-speed signal monitoring unit 222 switches off signal transmitting unit 202 and switches on signal receiving unit 204. In one aspect, signal receiving unit 204 receives one or more high-speed optical signals via optical communication channel 114. Photodetector 220 may convert the high-speed optical signals into a corresponding set of receive high-speed electrical signals. RX circuit 218 may perform signal conditioning and amplification on the receive high-speed electrical signals, and transmit the conditioned receive high-speed electrical signals, for example, to communication signal sink 110 via high-speed signal interface 206, and high-speed electrical communication link 210.

In one aspect, both signal transmitting unit 202 and signal receiving unit 204 communicate (i.e., transmit and receive, respectively) high-speed signals in a half-duplex manner using a common high-speed electrical interface 206. High-speed electrical interface 206 functions as a half-duplex electrical interface. To enable this functionality, an appropriate termination control unit may be included in each of signal transmitting unit 202 and signal receiving unit 204. The termination control unit in signal transmitting unit 202 prevents signals received by signal receiving unit 204 from being routed to transmit circuit 214 when terminal 104 is in a receive mode (i.e., when signal receiving unit 204 is switched on and signal transmitting unit 202 is switched off). The termination control unit in signal receiving unit 204 prevents signals transmitted by signal transmitting unit 202 from being routed to receive circuit 218 when terminal 104 is in a transmit mode (i.e., when signal receiving unit 204 is switched off and signal transmitting unit 202 is switched on).

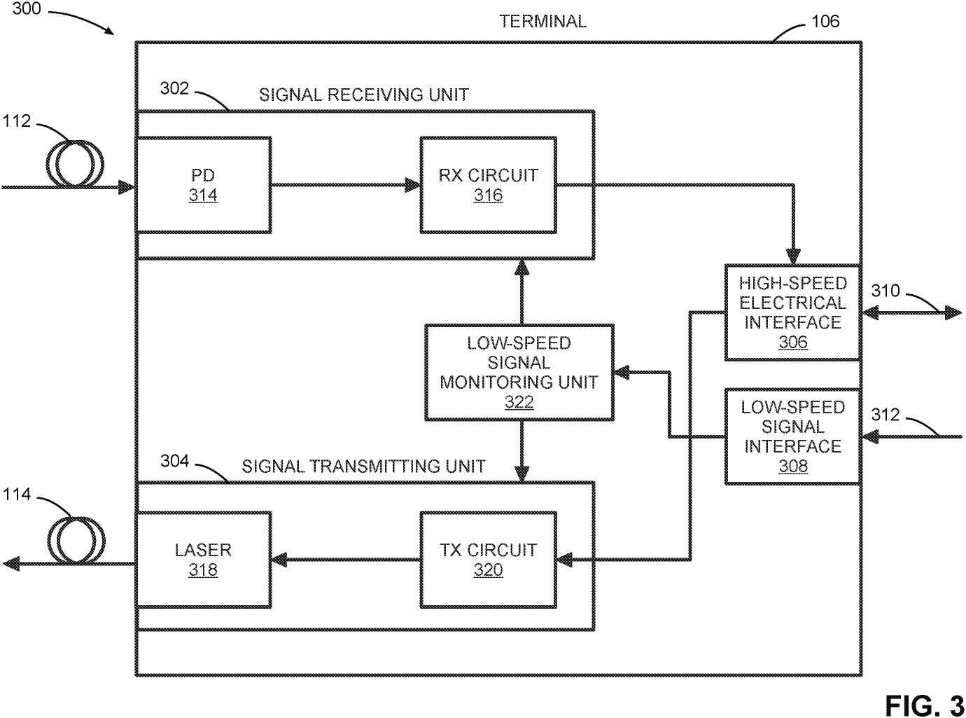

FIG. 3 is a block diagram depicting an embodiment of a terminal interface 300. As depicted, terminal interface 300 includes terminal 106, high-speed electrical communication link 310, low-speed electrical communication link 312, optical communication channel 112, and optical communication channel 114. Terminal 106 further includes high-speed electrical interface 306, low-speed signal interface 308, signal receiving unit 302, low-speed signal monitoring unit 322, and signal transmitting unit 304. Signal receiving unit 302 further includes receive (RX) circuit 316, and photodetector (PD) 314. Signal transmitting unit 304 further includes transmit (TX) circuit 320, and laser 318.

In one aspect, high-speed electrical communication link 310 and low-speed electrical communication link 312 are included in bidirectional communication link 118, for example, if terminal 106 is connected to communication signal sink 110. High-speed electrical communication link 310 and low-speed electrical communication link 312 may be included in bidirectional communication link 122, for example, if terminal 106 is connected to communication signal source 108. In one aspect, high-speed electrical communication link 310 is a bidirectional communication link.

In one aspect, terminal 106 receives one or more low-speed electrical signals from a connected communication signal source (e.g., communication signal source 108) or a communication signal sink (e.g., communication signal sink 110) via low-speed electrical communication link 312. The low-speed electrical signals may be transmitted by low-speed signal interface 308 to low-speed signal monitoring unit 322.

In one aspect, low-speed signal monitoring unit 322 analyzes the low-speed signals received from low-speed signal interface 308 to determine whether terminal 106 is connected to communication signal source 108 or to communication signal sink 110. In other words, low-speed signal monitoring unit 322 monitors the low-speed signals received from low-speed signal interface 308.

If terminal 106 is connected to communication signal sink 110, then low-speed signal monitoring unit 322 determines that terminal 106 functions as a receive terminal, in a reception mode. In this aspect, low-speed signal monitoring unit 322 switches off signal transmitting unit 304, and switches on signal receiving unit 302. In one aspect, signal receiving unit 302 receives one or more high-speed optical signals via optical communication channel 112. Photodetector 314 may convert the high-speed optical signals into a corresponding set of receive high-speed electrical signals. RX circuit 316 may perform signal conditioning and amplification on the receive high-speed electrical signals, and transmit the conditioned receive high-speed electrical signals to, for example, communication signal sink 110 via high-speed signal interface 306, and high-speed electrical communication link 310.

If terminal 106 is connected to communication signal source 108, then low-speed signal monitoring unit 322 determines that terminal 106 functions as a transmit terminal, in a transmission mode. In this aspect, low-speed signal monitoring unit 322 switches on signal transmitting unit 304, and switches off signal receiving unit 302. In one aspect, a switching on or switching off process for signal transmitting unit 304 or signal transmitting unit 302 may be implemented by respectively turning on or turning off respective power supplies to the associated unit. High-speed electrical interface 306 may receive one or more high-speed electrical signals from communication signal source 108. In one aspect, TX circuit 320 receives the high-speed electrical signals via high-speed electrical interface 306. TX circuit 320 may amplify and condition the high-speed electrical signals, and drive laser 318 to convert the high-speed electrical signals into high-speed optical signals. The high-speed optical signals output by laser 318 may be transmitted, for example, to terminal 104 via optical communication channel 114. In one aspect, laser 318 is any of a vertical-cavity surface-emitting laser (VCSEL), a laser diode, or any other kind of laser.

In one aspect, both signal transmitting unit 304 and signal receiving unit 302 communicate (i.e., transmit and receive, respectively) high-speed signals in a half-duplex manner using a common high-speed electrical interface 306. High-speed electrical interface 306 functions as a half-duplex electrical interface. To enable this functionality, an appropriate termination control unit may be included in each of signal transmitting unit 304 and signal receiving unit 302. The termination control unit in signal transmitting unit 304 prevents signals received by signal receiving unit 302 from being routed to transmit circuit 320 when terminal 106 is in a receive mode (i.e., when signal receiving unit 302 is switched on and signal transmitting unit 304 is switched off). The termination control unit in signal receiving unit 302 prevents signals transmitted by signal transmitting unit 304 from being routed to receive circuit 316 when terminal 106 is in a transmit mode (i.e., when signal receiving unit 302 is switched off and signal transmitting unit 304 is switched on).

As depicted in FIGS. 2 and 3, terminals 104 and 106 have a similar functional architecture. In one aspect, each of terminal 104 and 106 includes a separate signal chain comprising a high-speed electrical interface, a signal transmitting circuit, and a signal receiving circuit, for each high-speed electrical signal transmitted or received by the terminal. Correspondingly, optical communication channels 112 and 114 each includes a distinct set of optical fibers for each high-speed optical signal transmitted or received by optical connector 102.

In one aspect, optical connector 102 includes terminals 104 and 106 optically connected via M (a selected number of) optical fiber groups included in each of optical communication channels 112 and 114. Optical communication channels 112 and 114 may be unidirectional optical communication channels with similar construction, but with opposite communication directions.

In one aspect, each of terminal 104 and 106 includes M high-speed electrical interfaces, M signal transmitting units, M signal receiving units, N low-speed signal interfaces and N low-speed signal monitoring units, where M is a positive integer greater than or equal to 1, and N is equal to 1 or M.

High-speed signals and low-speed signals are concepts used in the field of signal transmission. Generally speaking, when a transmission path length of a signal is less than ⅙ of the effective wavelength of the signal, it can be considered that signal levels at all points on the transmission path are approximately the same, and the signal is a low-speed signal; otherwise, the signal is a high-speed signal.

In one aspect, in each of terminal 104 and 106, M high-speed electrical interfaces are respectively connected with M signal transmitting units and M signal receiving units correspondingly; N low-speed signal interfaces are correspondingly connected with N low-speed signal monitoring units respectively. When N is equal to 1, the single low-speed signal monitoring unit (e.g., low-speed signal monitoring unit 222 or 322) is connected with each signal transmitting unit and each signal receiving unit. When N is equal to M, N low-speed signal monitoring units may be correspondingly connected with M signal transmitting units and M signal receiving units in a one-to-one manner, where each low-speed signal monitoring unit is connected to a unique signal transmitting unit and a unique signal receiving unit.

In one aspect, optical fiber bundles included in optical communication channel 112 are correspondingly connected with M signal transmitting units in terminal 104 and M signal receiving units in terminal 106 respectively; the signals in each optical fiber bundle are transmitted from terminal 104 to terminal 106.

In one aspect, optical fiber bundles included in optical communication channel 114 are correspondingly connected with M signal receiving units in terminal 104 and M signal transmitting units in terminal 106 respectively; the signals in each optical fiber bundle are transmitted from terminal 106 to terminal 104.

In general, a signal transmitting unit (e.g., signal transmitting unit 202 or 304) may be configured to receive electrical signals from a high-speed electrical interface (e.g., high-speed electrical interface 206 or 306), convert the electrical signals into corresponding high-speed optical signals, and transmit the high-speed optical signals via an optical communication channel (e.g., optical communication channel 112 or 114). A signal receiving unit (e.g., signal receiving unit 204 or 302) may be configured to receive optical signals from the optical path of the optical communication channel (e.g., optical communication channel 114 or 112), convert the optical signals into corresponding electrical signals, transmit them to a high-speed electrical interface (e.g., high-speed electrical interface 206 or 306).

In one aspect, a low-speed signal interface (e.g., low-speed signal interface 208 or 308) is used to receive a low-speed electrical signal indicating a transfer mode (i.e., a transmission mode or a reception mode) and transfer direction information of the associated high-speed electrical signals. A low-speed signal monitoring unit (e.g., low-speed signal monitoring unit 222 or 322) can monitor the corresponding low-speed signal interface (i.e., low-speed signal interface 208 or 308, respectively), and acquire the transfer mode and a direction of signal transfer (i.e., transmission or reception).

Depending on the transfer mode (e.g., transmission or reception), low-speed signal monitoring unit 222 turns on signal transmitting unit 202 and turns off signal receiving unit 204 or turns off signal transmitting unit 202 and turns on signal receiving unit 204, respectively. Depending on the transfer mode, low-speed signal monitoring unit 322 turns on signal transmitting unit 304 and turns off signal receiving unit 302, or turns off signal transmitting unit 304 and turns on signal receiving unit 302, respectively. The design of optical connector 102 makes it possible to dynamically change the transmission direction of high-speed photoelectric signals and enables half-duplex communication of high-speed photoelectric signals.

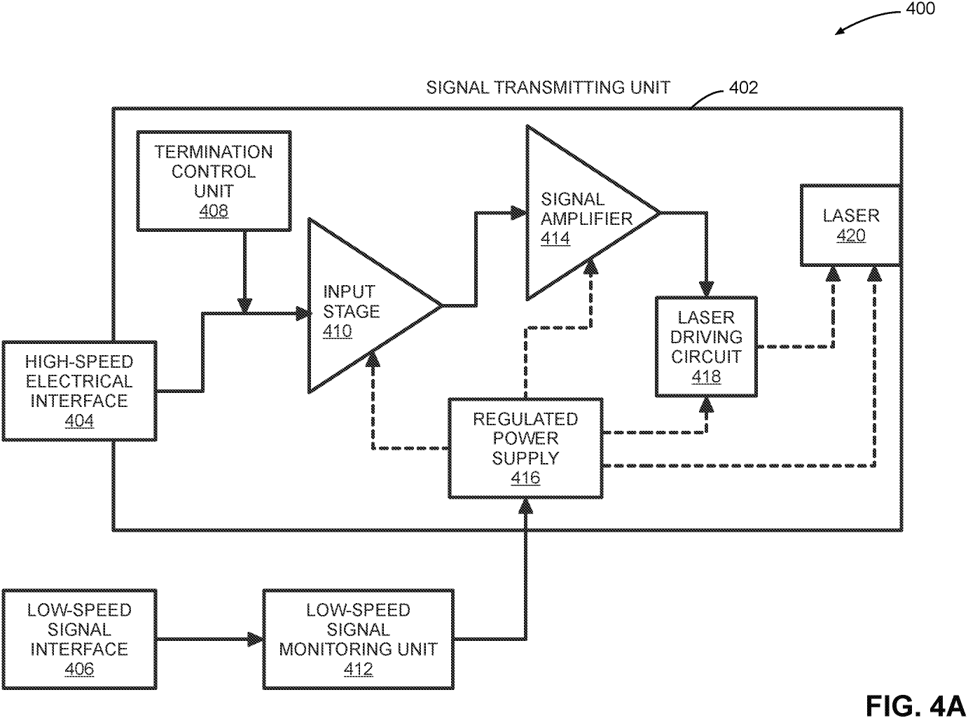

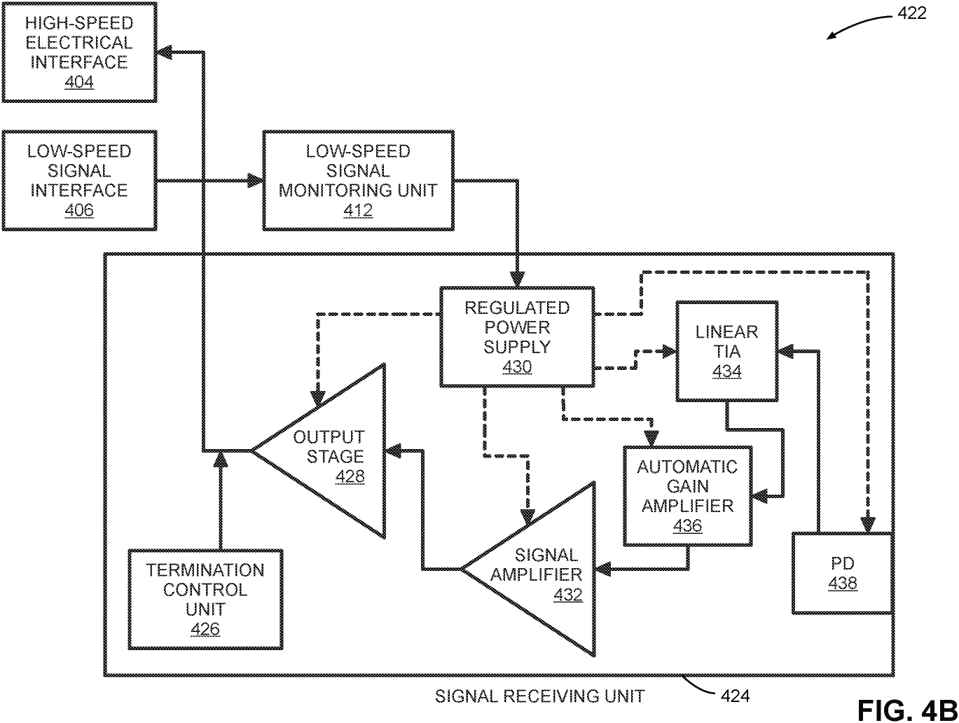

FIG. 4A is a block diagram depicting an embodiment of a signal transmitting unit interface 400. As depicted, signal transmitting unit interface 400 includes signal transmitting unit 402, high-speed electrical interface 404, low-speed signal interface 406, and low-speed signal monitoring unit 412. Signal transmitting unit 402 further includes termination control unit 408, input stage 410, regulated power supply 416, signal amplifier 414, laser driving circuit 418, and laser 420.

Signal transmitting unit 402 may be similar to signal transmitting unit 202 or 304. High-speed electrical interface 404 may be similar to high-speed electrical interface 206 or 306. Low-speed signal interface 406 may be similar to low-speed signal interface 208 or 308. Low-speed signal monitoring unit 412 may be similar to low-speed signal monitoring unit 222 or 322. A combination of termination control unit 408, input stage 410, regulated power supply 416, signal amplifier 414, and laser driving circuit 418 may be similar to TX circuit 214 or 320.

In one aspect, low-speed signal monitoring unit 412 monitors one or more low-speed signals received at low-speed signal interface 406. Low-speed signal monitoring unit 412 may analyze the low-speed signals to determine whether the associated terminal (i.e., terminal 104 or 106) is connected to a communication signal source (e.g., communication signal source 108). If the terminal is connected to a communication signal source, then low-speed signal monitoring unit 412 activates regulated power supply 416 to supply power to input stage 410, signal amplifier 414, laser driving circuit 418, and laser 420. This is similar to low-speed signal monitoring unit 222 or 322 turning on signal transmitting unit 202 or 304, respectively. If the terminal is connected to a communication signal sink, then low-speed signal monitoring unit 412 switches and maintains regulated power supply 416 in an off state. In this state, input stage 410, signal amplifier 414, laser driving circuit 418, and laser 420 are powered down, thereby saving power. This is similar to low-speed signal monitoring unit 222 or 322 turning off signal transmitting unit 202 or 304, respectively.

If the terminal is connected to a communication signal source, then high-speed electrical interface 404 receives one or more high-speed electrical signals from the communication signal source (e.g., from communication signal source 108). Input stage 410 receives these high-speed electrical signals from high-speed electrical interface 404, and performs preamplification and signal conditioning on the high-speed electrical signals. Termination control unit 408 is connected to the input of input stage 410. Termination control unit 408 provides appropriate signal termination so that signal transmitting unit 402 can share a common high-speed electrical interface 404 with a corresponding signal receiving unit.

In one aspect, signal amplifier 414 amplifies an output of input stage 410, and transmits the amplified high-speed electrical signals to laser driving circuit 418. Laser driving circuit 418 can drive laser 420 using the amplified high-speed electrical signals, thereby converting the high-speed electrical signals into high-speed optical signals. The high-speed optical signals may be transmitted over an optical communication channel such as optical communication channel 112 or optical communication channel 114.

FIG. 4B is a block diagram depicting an embodiment of a signal receiving unit interface 422. As depicted, signal receiving unit interface 422 includes signal receiving unit 424, high-speed electrical interface 404, low-speed signal interface 406, and low-speed signal monitoring unit 412. Signal transmitting unit 424 further includes termination control unit 426, photodetector PD 438, linear transimpedance amplifier 434, automatic gain amplifier 436, signal amplifier 432, regulated power supply 430, and output stage 428.

Signal receiving unit 424 may be similar to signal receiving unit 204 or 302. High-speed electrical interface 404 may be similar to high-speed electrical interface 206 or 306. Low-speed signal interface 406 may be similar to low-speed signal interface 208 or 308. Low-speed signal monitoring unit 412 may be similar to low-speed signal monitoring unit 222 or 322. A combination of termination control unit 426, linear transimpedance amplifier 434, automatic gain amplifier 436, signal amplifier 432, regulated power supply 430, and output stage 428 may be similar to RX circuit 218 or 316.

In one aspect, low-speed signal monitoring unit 412 monitors one or more low-speed signals received at low-speed signal interface 406. Low-speed signal monitoring unit 412 may analyze the low-speed signals to determine whether the associated terminal (i.e., terminal 104 or 106) is connected to a communication signal sink (e.g., communication signal source 110). If the terminal is connected to a communication signal sink, then low-speed signal monitoring unit 412 activates regulated power supply 430 to supply power to photodetector 438, linear transimpedance amplifier 434, automatic gain amplifier 436, signal amplifier 432, and output stage 428. This is similar to low-speed signal monitoring unit 222 or 322 turning on signal receiving unit 204 or 302, respectively. If the terminal is connected to a communication signal source, then low-speed signal monitoring unit 412 switches and maintains regulated power supply 430 in an off state. In this state, photodetector 438, linear transimpedance amplifier 434, automatic gain amplifier 436, signal amplifier 432, and output stage 428 are powered down, thereby saving power. This is similar to low-speed signal monitoring unit 222 or 322 turning off signal receiving unit 204 or 302, respectively.

If the terminal is connected to a communication signal sink, then photodetector 438 receives one or more high-speed optical signals over an optical communication channel such as optical communication channel 112 or 114. Photodetector 438 converts the high-speed optical signals into receive high-speed electrical signals. Linear transimpedance amplifier 434 performs linear amplification on the receive high-speed electrical signals. Automatic gain amplifier 436 receives the linearly-amplified receive high-speed electrical signals and performs automatic gain compensation on these signals, to compensate for variable gain or signal loss over optical communication channel 112 or 114. Signal amplifier 432 performs further signal conditioning and amplification on the gain-compensated signals. Output stage 428 receives the output signals from signal amplifier 432, performs additional amplification and impedance matching on these signals, and transmits the signals as high-speed electrical signals to a communication signal sink (e.g., communication signal sink 110) via high-speed electrical interface 404.

In one aspect, termination control unit 426 is connected to the output of output stage 428. Termination control unit 426 provides appropriate signal termination so that signal receiving unit 424 can share a common high-speed electrical interface 404 with signal transmitting unit 402.

In one aspect, termination control unit 408 terminates the input of signal transmitting unit 402 (i.e., the input of input stage 410). Termination control unit 426 terminates the output of signal receiving unit 424 (i.e., the output of output stage 428). Termination control unit 408 and 426 allow signal transmitting unit 402 and signal receiving unit 424 to share the same high-speed electrical interface 404. In contemporary systems, the output of high-speed signals generally adopts a current mode interface output structure (also known as current-mode logic, or CML), or a voltage-mode interface output structure (also known as voltage-mode logic, or VML). High-speed electrical interface 206 is designed such that the output of output stage 428 (that is, the output of signal receiving unit 424) is short-circuit-connected to the interface of the input of input stage 410 (i.e., the input of signal transmitting unit 402).

In one aspect, the tail current of output stage 428 and the regulated power supply 430 are received through the low-speed signal monitoring unit 412. Due to this, a high-speed electrical signal received from high-speed signal interface 404 in a transmit mode can only be converted into an optical signal through signal transmitting unit 402 (i.e., TX circuit 214 or 320) and the laser 420, while no signal is reversely transmitted from the photodetector 438 to the high-speed electrical interface 404 due to the turning off of signal receiving unit 424. On the other hand, when low-speed signal monitoring unit 412 controls signal transmitting unit 402 to turn off and signal receiving unit 424 to turn on, a receive high-speed electrical signal as converted from a high-speed optical signal by photodetector 438 is transmitted from the photodetector 438 to high-speed electrical interface 404 via the associated signal chain from linear transimpedance amplifier 434 to output stage 428. In this case, there is no signal transmission from the high-speed electrical interface 404 to laser 420.

In one aspect, termination control units 408 and 426 are implemented on an integrated circuit that includes signal transmitting unit 402 and signal receiving unit 424. Such a design may ensure that the high-speed transmission line involved in this connection is as short as possible. For such an implementation the characteristic impedance may be reasonably selected through electromagnetic simulation, so as to reduce the influence of signal reflection when the high-speed signal propagates. At the same time, the termination control units 408 and 426 may be designed to select a resistance value matching with the transmission line corresponding to the input and output signal chains.

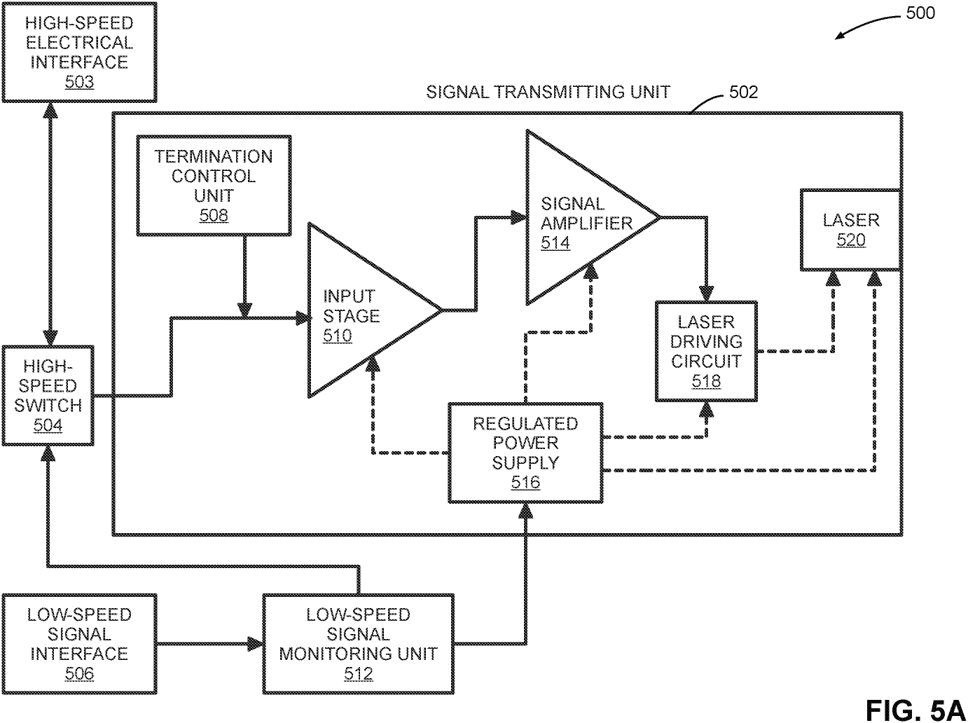

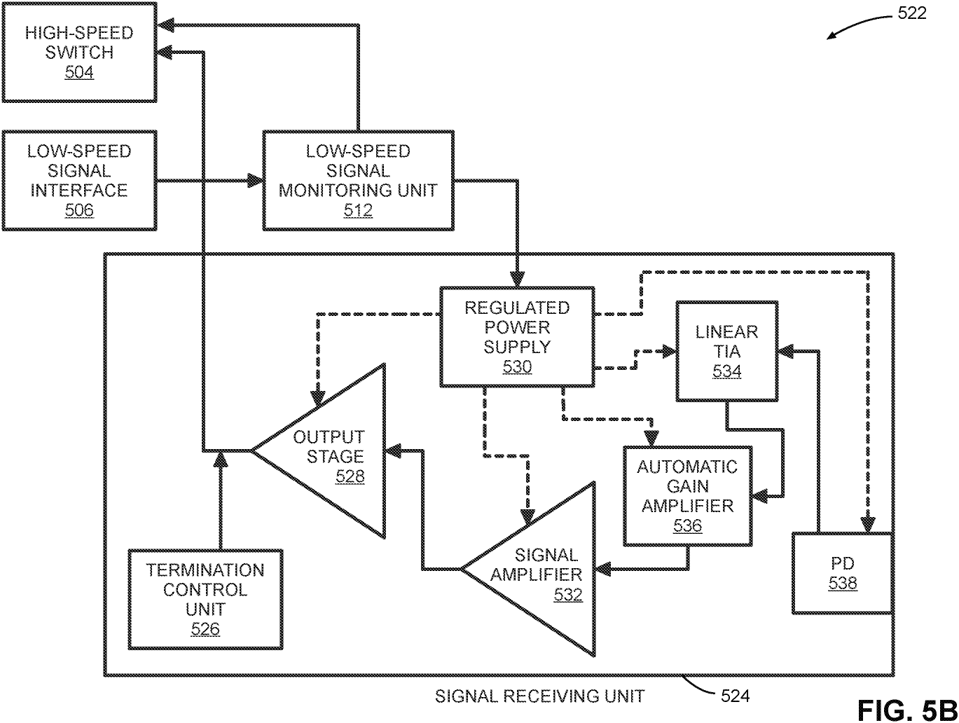

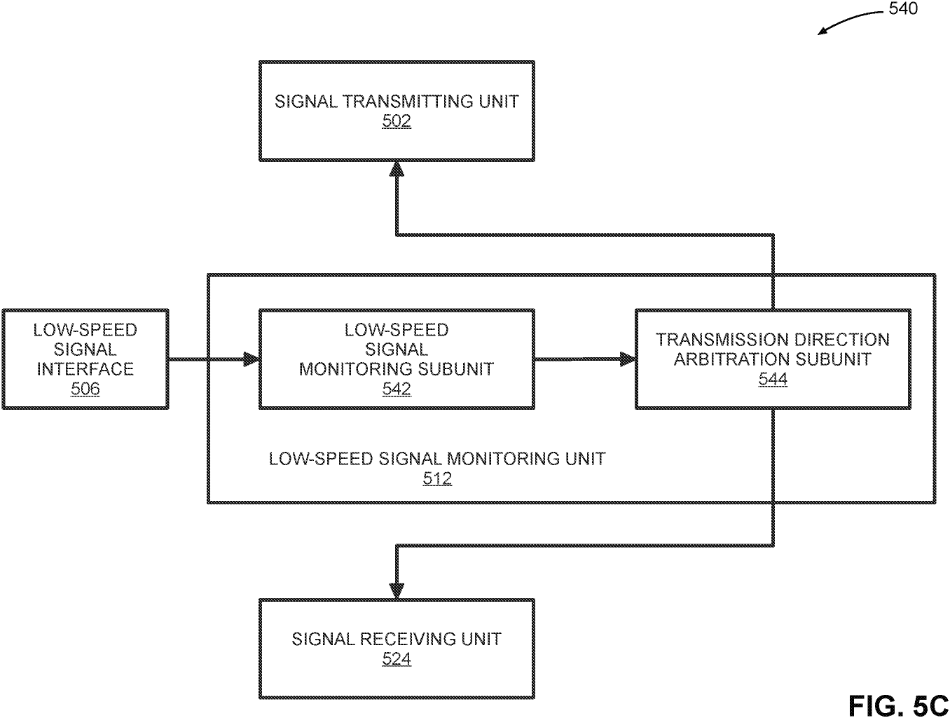

FIG. 5A is a block diagram depicting an embodiment of a signal transmitting unit interface 500. As depicted, signal transmitting unit interface 500 includes signal transmitting unit 502, high-speed electrical interface 503, high-speed switch 504, low-speed signal interface 506, and low-speed signal monitoring unit 512. Signal transmitting unit 502 further includes termination control unit 508, input stage 510, regulated power supply 516, signal amplifier 514, laser driving circuit 518, and laser 520.

Signal transmitting unit 502 may be similar to signal transmitting unit 202 or 304. High-speed electrical interface 503 may be similar to high-speed electrical interface 206 or 306. Low-speed signal interface 506 may be similar to low-speed signal interface 208 or 308. Low-speed signal monitoring unit 512 may be similar to low-speed signal monitoring unit 222 or 322. A combination of termination control unit 508, input stage 510, regulated power supply 516, signal amplifier 514, and laser driving circuit 518 may be similar to TX circuit 214 or 320.

In one aspect, low-speed signal monitoring unit 512 monitors one or more low-speed signals received at low-speed signal interface 506. Low-speed signal monitoring unit 512 may analyze the low-speed signals to determine whether the associated terminal (i.e., terminal 104 or 106) is connected to a communication signal source (e.g., communication signal source 108). If the terminal is connected to a communication signal source, then low-speed signal monitoring unit 512 activates regulated power supply 516 to supply power to input stage 510, signal amplifier 514, laser driving circuit 518, and laser 520. This is similar to low-speed signal monitoring unit 222 or 322 turning on signal transmitting unit 202 or 304, respectively. At the same time, low-speed signal monitoring unit 512 switches high-speed switch 504 such that one or more high-speed electrical signals received from communication signal source (e.g., communication signal source 108) are routed to input stage 510.

If the terminal is connected to a communication signal sink, then low-speed signal monitoring unit 512 switches and maintains regulated power supply 516 in an off state. In this state, input stage 510, signal amplifier 514, laser driving circuit 518, and laser 520 are powered down, thereby saving power. This is similar to low-speed signal monitoring unit 222 or 322 turning off signal transmitting unit 202 or 304, respectively. At the same time, low-speed signal monitoring unit 512 switches high-speed switch 504 such that no high-speed electrical signals received by a corresponding signal receiving unit are routed to input stage 510.

If the terminal is connected to a communication signal source, then high-speed electrical interface 503 receives one or more high-speed electrical signals from the communication signal source (e.g., from communication signal source 108). The high-speed electrical signals are routed to input stage 510 via high-speed switch 504, where high-speed switch 504 has been switched by low-speed signal monitoring unit 512 to route these high-speed electrical signals. Input stage 510 receives these high-speed electrical signals from high-speed electrical interface 503, and performs preamplification and signal conditioning on the high-speed electrical signals. Termination control unit 508 is connected to the input of input stage 510. Termination control unit 508 provides appropriate signal termination so that signal transmitting unit 502 can share a common high-speed electrical interface 503 with a corresponding signal receiving unit.

In one aspect, signal amplifier 514 amplifies an output of input stage 510, and transmits the amplified high-speed electrical signals to laser driving circuit 518. Laser driving circuit 518 can drive laser 520 using the amplified high-speed electrical signals, thereby converting the high-speed electrical signals into high-speed optical signals. The high-speed optical signals may be transmitted over an optical communication channel such as optical communication channel 112 or optical communication channel 114.

FIG. 5B is a block diagram depicting an embodiment of a signal receiving unit interface 522. As depicted, signal receiving unit interface 522 includes signal receiving unit 524, high-speed switch 504, low-speed signal interface 506, and low-speed signal monitoring unit 512. Signal transmitting unit 524 further includes termination control unit 526, photodetector PD 538, linear transimpedance amplifier 534, automatic gain amplifier 536, signal amplifier 532, regulated power supply 530, and output stage 528.

Signal receiving unit 524 may be similar to signal receiving unit 204 or 302. Low-speed signal interface 506 may be similar to low-speed signal interface 208 or 308. Low-speed signal monitoring unit 512 may be similar to low-speed signal monitoring unit 222 or 322. A combination of termination control unit 526, linear transimpedance amplifier 534, automatic gain amplifier 536, signal amplifier 532, regulated power supply 530, and output stage 528 may be similar to RX circuit 218 or 316.

In one aspect, low-speed signal monitoring unit 512 monitors one or more low-speed signals received at low-speed signal interface 506. Low-speed signal monitoring unit 512 may analyze the low-speed signals to determine whether the associated terminal (i.e., terminal 104 or 106) is connected to a communication signal sink (e.g., communication signal source 110). If the terminal is connected to a communication signal sink, then low-speed signal monitoring unit 512 activates regulated power supply 530 to supply power to photodetector 538, linear transimpedance amplifier 534, automatic gain amplifier 536, signal amplifier 532, and output stage 528. This is similar to low-speed signal monitoring unit 222 or 322 turning on signal receiving unit 204 or 302, respectively. At the same time, low-speed signal monitoring unit 512 switches high-speed switch 504 such that one or more high-speed electrical signals received by signal receiving unit 524 and output by output stage 528 are routed to high-speed electrical interface 503 via high-speed switch 504.

If the terminal is connected to a communication signal source, then low-speed signal monitoring unit 512 switches and maintains regulated power supply 530 in an off state. In this state, photodetector 538, linear transimpedance amplifier 534, automatic gain amplifier 536, signal amplifier 532, and output stage 528 are powered down, thereby saving power. This is similar to low-speed signal monitoring unit 222 or 322 turning off signal receiving unit 204 or 302, respectively. At the same time, low-speed signal monitoring unit 512 switches high-speed switch 504 such that no high-speed electrical signals received at input stage 510 of signal transmitting unit 502 are routed to an output of output stage 528.

If the terminal is connected to a communication signal sink, then photodetector 538 receives one or more high-speed optical signals over an optical communication channel such as optical communication channel 112 or 114. Photodetector 538 converts the high-speed optical signals into receive high-speed electrical signals. Linear transimpedance amplifier 534 performs linear amplification on the receive high-speed electrical signals. Automatic gain amplifier 536 receives the linearly-amplified receive high-speed electrical signals and performs automatic gain compensation on these signals, to compensate for variable gain or signal loss over optical communication channel 112 or 114. Signal amplifier 532 performs further signal conditioning and amplification on the gain-compensated signals. Output stage 528 receives the output signals from signal amplifier 532, performs additional amplification and impedance matching on these signals, and transmits the signals as high-speed electrical signals to a communication signal sink (e.g., communication signal sink 110) via high-speed switch 504, and high-speed electrical interface 503. In this state, high-speed switch 504 has been switched by low-speed signal monitoring unit 512 to route these high-speed electrical signals to high-speed electrical interface, and not to input stage 510.

In one aspect, termination control unit 526 is connected to the output of output stage 528. Termination control unit 526 provides appropriate signal termination so that signal receiving unit 524 can share a common high-speed electrical interface 503 with signal transmitting unit 502.

In one aspect, termination control units 408 and 426 directly terminate the transmitting circuit TX components of signal transmitting unit 402, and the receiving circuit RX components of signal receiving unit 424. Such a structure brings challenges to the design of the associated transmission lines. And whether the signal propagation direction is configured from the high-speed electrical interface 404 to laser 420, or from the photodetector 438 to high-speed electrical interface 404, the termination control units 408 and 426 must maintain the terminated connection to ensure that the high-speed signal (whether being transmitted or received) does not emit greatly at the two endpoints. As a result, the amplitude of the signal input by the transmitting circuit TX (i.e., the signal chain from input stage 410 through laser 420) is reduced by about half. Also, the amplitude of the signal output by the receiving circuit RX (i.e., the signal chain from photodetector 438 through output stage 428) is reduced by about half.

To solve this problem, a terminal that includes signal transmitting unit 502 and signal receiving unit 524 separates the input of the transmitting circuit TX (i.e., the input of the signal chain from input stage 510 through laser 520) from the output of the receiving circuit RX (i.e., the output of the signal chain from photodetector 538 through output stage 528) by using high-speed switch 504. In one aspect, high-speed switch 504 is any of a high-speed RF switch, a mechanical switch, or a microelectromechanical systems (MEMS) switch. High-speed switch 504 may be controlled by low-speed signal monitoring unit 512. With this design using high-speed switch 504, the physical separation of the transmission lines from the transmit input (i.e., the input of input stage 510) of the associated transmitting circuit and the receive output (i.e., the output of output stage 528) of the associated receiving circuit is realized. Appropriate impedance matching is implemented by this design, and the amplitudes of the input signal and the output signal are increased.

In one aspect, the input end of signal transmitting unit 502 (i.e., the input of input stage 510) and the output end of signal receiving unit 524 (i.e., the output of output stage 528) are connected via high-speed switch 504. High-speed switch 504 may also connected with high-speed electrical interface 503 and low-speed signal monitoring unit 512. In one aspect, low-speed signal monitoring unit 512 is also used to control the switching process of high-speed switch 504. As a specific embodiment, the high-speed switch 504 is a high-speed radio frequency switch or a MEMS (Micro-Electro-Mechanical System) switch.

FIG. 5C is a block diagram depicting an embodiment of a signal monitoring unit interface 540. As depicted, signal monitoring unit interface 540 includes low-speed signal interface 506, low-speed signal monitoring unit 512, signal transmitting unit 502, and signal receiving unit 524. Low-speed signal monitoring unit 512 further includes low-speed signal monitoring subunit 542, and transmission direction arbitration subunit 544.

In one aspect, low-speed signal monitoring subunit 542 receives one or more low-speed signals from low-speed signal interface 506. Low-speed signal monitoring subunit 542 may analyze the low-speed signals to determine whether the corresponding terminal is connected to a communication signal source or to a communication signal sink. Low-speed signal monitoring subunit 542 may also determine a transmission protocol and/or a transmission mode based on this analysis. If low-speed signal monitoring subunit 542 determines that the terminal is connected to a communication signal source (e.g., communication signal source 108), then low-speed signal monitoring subunit 542 commands transmission direction arbitration subunit 544 to turn on signal transmitting unit 502 and turn off signal receiving unit 524. If low-speed signal monitoring subunit 542 determines that the terminal is connected to a communication signal sink (e.g., communication signal sink 110), then low-speed signal monitoring subunit 542 commands transmission direction arbitration subunit 544 to turn off signal transmitting unit 502 and turn on signal receiving unit 524. In one aspect, the turning on or turning off processes are accomplished by transmission direction arbitration subunit turning on or off regulated power supply 516 or 530, respectively, depending on whether a transmission mode or a reception mode is selected.

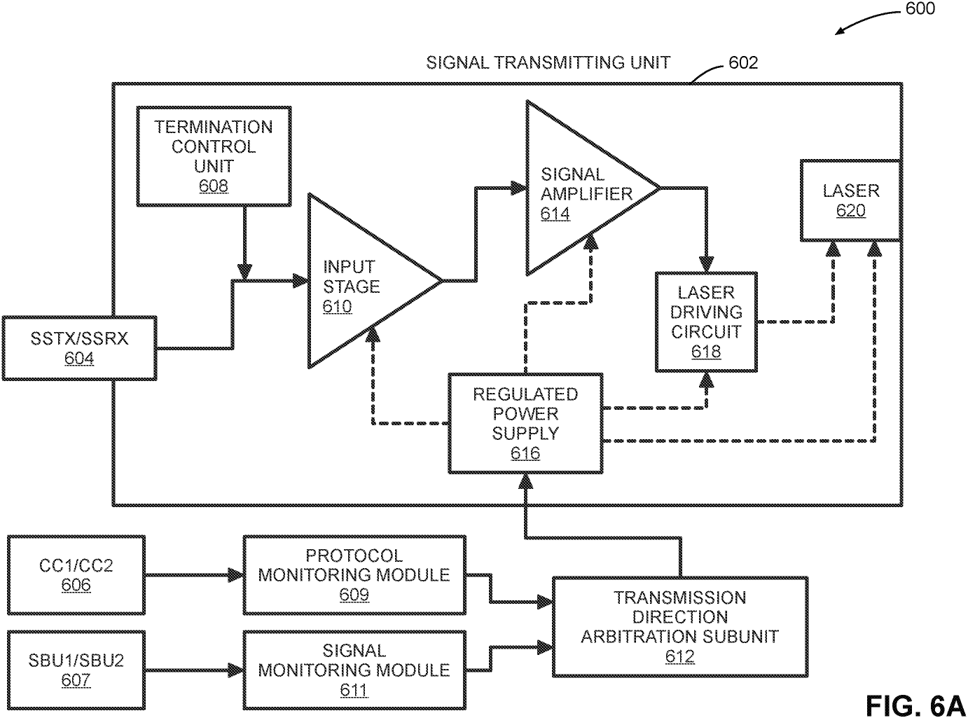

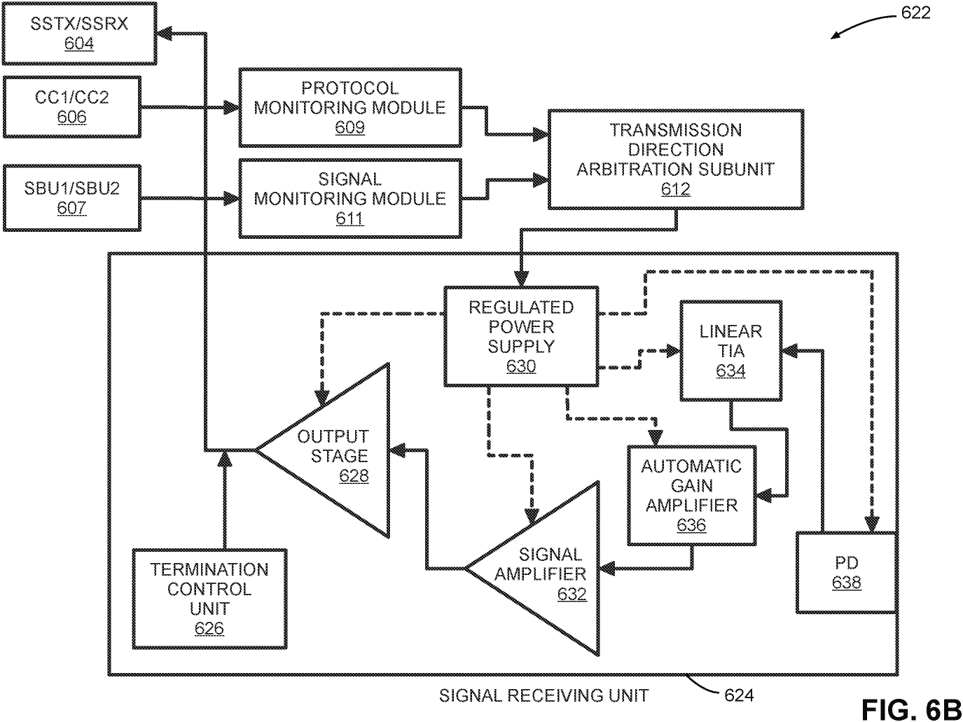

FIG. 6A is a block diagram depicting an embodiment of a signal transmitting unit interface 600. As depicted, signal transmitting unit interface 600 includes signal transmitting unit 602, SSTX/SSRX interface 604, CC1/CC2 interface 606, SBU1/SBU2 interface 607, protocol monitoring module 609, signal monitoring module 611, and transmission direction arbitration subunit 612. Signal transmitting unit 602 further includes termination control unit 608, input stage 610, regulated power supply 616, signal amplifier 614, laser driving circuit 618, and laser 620. Signal transmitting interface 600 may be used as a Universal Serial Bus (USB)/Lightning transmitting interface.

Signal transmitting unit 602 may be similar to signal transmitting unit 202 or 304. SSTX/SSRX interface 604 may be similar to high-speed electrical interface 206 or 306. A combination of CC1/CC2 interface 606 and SBU1/SBU2 (Single Band Use) interface 607 may be similar to low-speed signal interface 208 or 308. A combination of protocol monitoring module 609, signal monitoring module 611, and transmission direction arbitration subunit 612 may be similar to low-speed signal monitoring unit 222 or 322. A combination of termination control unit 608, input stage 610, regulated power supply 616, signal amplifier 614, and laser driving circuit 618 may be similar to TX circuit 214 or 320.

In one aspect, CC1/CC2 interface 606 is a USB channel configuration interface that is configured to receive one or more low-speed signals (i.e., low-speed electrical signals) from a connected communication signal source (e.g., communication signal source 108) or communication signal sink (e.g., communication signal sink 110). Protocol monitoring module 609 may receive these low-speed signals from CC1/CC2 interface 606. Protocol monitoring module 609 may analyze a Power Delivery Protocol (i.e., a charging protocol) associated with these low-speed signals and determine whether the system is in a DisplayPort Alt mode or a conventional USB/Lightning protocol communication mode.

In one aspect, signal monitoring module 611 receives one or more low-speed electrical signals from SBU1/SBU2 interface 607. SBU1/SBU2 interface 607 is a sideband interface that receives one or more sideband signals from a communication signal source (e.g., communication signal source 108) or a communication signal sink (e.g., communication signal sink 110). Signal monitoring module 611 may monitor a sideband signal or an AUX signal (i.e., an auxiliary signal), so that the transmission direction arbitration subunit 612 can judge the transmission direction of the signal according to the signal type.

Based on the analysis of protocol monitoring module 609 and signal monitoring module 611, transmission direction arbitration subunit 612 can determine a transmission or reception (i.e., transfer) direction of the signal according to the transmission mode (i.e., whether a terminal associated with signal transmitting unit 602 is connected to a communication signal source or a communication signal sink, respectively).

If the terminal associated with signal transmitting unit 602 is connected to a communication signal source, then transmission direction arbitration subunit 612 activates regulated power supply 616 to supply power to input stage 610, signal amplifier 614, laser driving circuit 618, and laser 620. This is similar to low-speed signal monitoring unit 222 or 322 turning on signal transmitting unit 202 or 304, respectively. If the terminal is connected to a communication signal sink, then transmission direction arbitration subunit 612 switches and maintains regulated power supply 616 in an off state. In this state, input stage 610, signal amplifier 614, laser driving circuit 618, and laser 620 are powered down, thereby saving power. This is similar to low-speed signal monitoring unit 222 or 322 turning off signal transmitting unit 202 or 304, respectively.

If the terminal is connected to a communication signal source, then SSTX/SSRX interface 604 receives one or more high-speed electrical signals (i.e., USB/Lightning signals) from the communication signal source (e.g., from communication signal source 108). Input stage 610 receives these high-speed electrical signals from SSTX/SSRX interface 604, and performs preamplification and signal conditioning on the high-speed electrical signals. Termination control unit 608 is connected to the input of input stage 610. Termination control unit 608 provides appropriate signal termination so that signal transmitting unit 602 can share a common SSTX/SSRX interface 604 with a corresponding signal receiving unit.

In one aspect, signal amplifier 614 amplifies an output of input stage 610, and transmits the amplified high-speed electrical signals to laser driving circuit 618. Laser driving circuit 618 can drive laser 620 using the amplified high-speed electrical signals, thereby converting the high-speed electrical signals into high-speed optical signals. The high-speed optical signals may be transmitted over an optical communication channel such as optical communication channel 112 or optical communication channel 114.

FIG. 6B is a block diagram depicting an embodiment of a signal receiving unit interface 622. As depicted, signal receiving unit interface 622 includes signal receiving unit 624, SSTX/SSRX interface 604, CC1/CC2 interface 606, SBU1/SBU2 interface 607, protocol monitoring module 609, signal monitoring module 611, and transmission direction arbitration subunit 612. Signal transmitting unit 624 further includes termination control unit 626, photodetector PD 638, linear transimpedance amplifier 634, automatic gain amplifier 636, signal amplifier 632, regulated power supply 630, and output stage 628. Signal receiving interface 624 may be used as a Universal Serial Bus (USB)/Lightning receiving interface.

Signal receiving unit 624 may be similar to signal receiving unit 204 or 302. SSTX/SSRX interface 604 may be similar to high-speed electrical interface 206 or 306. A combination of CC1/CC2 interface 606 and SBU1/SBU2 (Single Band Use) interface 607 may be similar to low-speed signal interface 208 or 308. A combination of protocol monitoring module 609, signal monitoring module 611, and transmission direction arbitration subunit 612 may be similar to low-speed signal monitoring unit 222 or 322. A combination of termination control unit 626, linear transimpedance amplifier 634, automatic gain amplifier 636, signal amplifier 632, regulated power supply 630, and output stage 628 may be similar to RX circuit 218 or 316.

In one aspect, CC1/CC2 interface 606 is a USB channel configuration interface that is configured to receive one or more low-speed signals (i.e., low-speed electrical signals) from a connected communication signal source (e.g., communication signal source 108) or communication signal sink (e.g., communication signal sink 110). Protocol monitoring module 609 may receive these low-speed signals from CC1/CC2 interface 606. Protocol monitoring module 609 may analyze a Power Delivery Protocol (i.e., a charging protocol) associated with these low-speed signals and determine whether the system is in a DisplayPort Alt mode or a conventional USB/Lightning protocol communication mode.

In one aspect, signal monitoring module 611 receives one or more low-speed electrical signals from SBU1/SBU2 interface 607. SBU1/SBU2 interface 607 is a sideband interface that receives one or more sideband signals from a communication signal source (e.g., communication signal source 108) or a communication signal sink (e.g., communication signal sink 110). Signal monitoring module 611 may monitor a sideband signal or an AUX signal (i.e., an auxiliary signal), so that the transmission direction arbitration subunit 612 can judge the transmission direction of the signal according to the signal type.

Based on the analysis of protocol monitoring module 609 and signal monitoring module 611, transmission direction arbitration subunit 612 can determine a transfer direction of the signal according to the transmission mode (i.e., whether a terminal associated with signal receiving unit 624 is connected to a communication signal source or a communication signal sink, respectively).

If the terminal is connected to a communication signal sink, transmission direction arbitration subunit 612 activates regulated power supply 630 to supply power to photodetector 638, linear transimpedance amplifier 634, automatic gain amplifier 636, signal amplifier 632, and output stage 628. This is similar to low-speed signal monitoring unit 222 or 322 turning on signal receiving unit 204 or 302, respectively. If the terminal is connected to a communication signal source, then transmission direction arbitration subunit 612 switches and maintains regulated power supply 630 in an off state. In this state, photodetector 638, linear transimpedance amplifier 634, automatic gain amplifier 636, signal amplifier 632, and output stage 628 are powered down, thereby saving power. This is similar to low-speed signal monitoring unit 222 or 322 turning off signal receiving unit 204 or 302, respectively.

If the terminal is connected to a communication signal sink, then photodetector 638 receives one or more high-speed optical signals over an optical communication channel such as optical communication channel 112 or 114. These high-speed optical signals may be USB/Lightning optical signals. Photodetector 638 converts the high-speed optical signals into receive high-speed electrical signals. Linear transimpedance amplifier 634 performs linear amplification on the receive high-speed electrical signals. Automatic gain amplifier 636 receives the linearly-amplified receive high-speed electrical signals and performs automatic gain compensation on these signals, to compensate for variable gain or signal loss over optical communication channel 112 or 114. Signal amplifier 632 performs further signal conditioning and amplification on the gain-compensated signals. Output stage 628 receives the output signals from signal amplifier 632, performs additional amplification and impedance matching on these signals, and transmits the signals as high-speed electrical signals to a communication signal sink (e.g., communication signal sink 110) via high-speed electrical interface 604.

In one aspect, termination control unit 626 is connected to the output of output stage 628. Termination control unit 626 provides appropriate signal termination so that signal receiving unit 624 can share a common SSTX/SSRX interface 604 with signal transmitting unit 602.

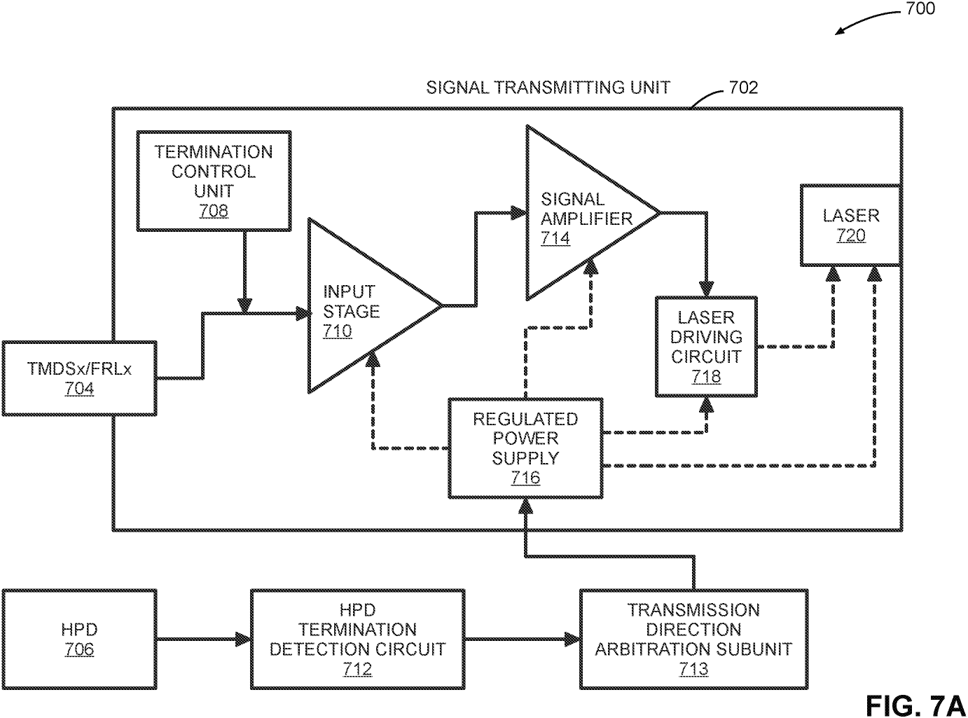

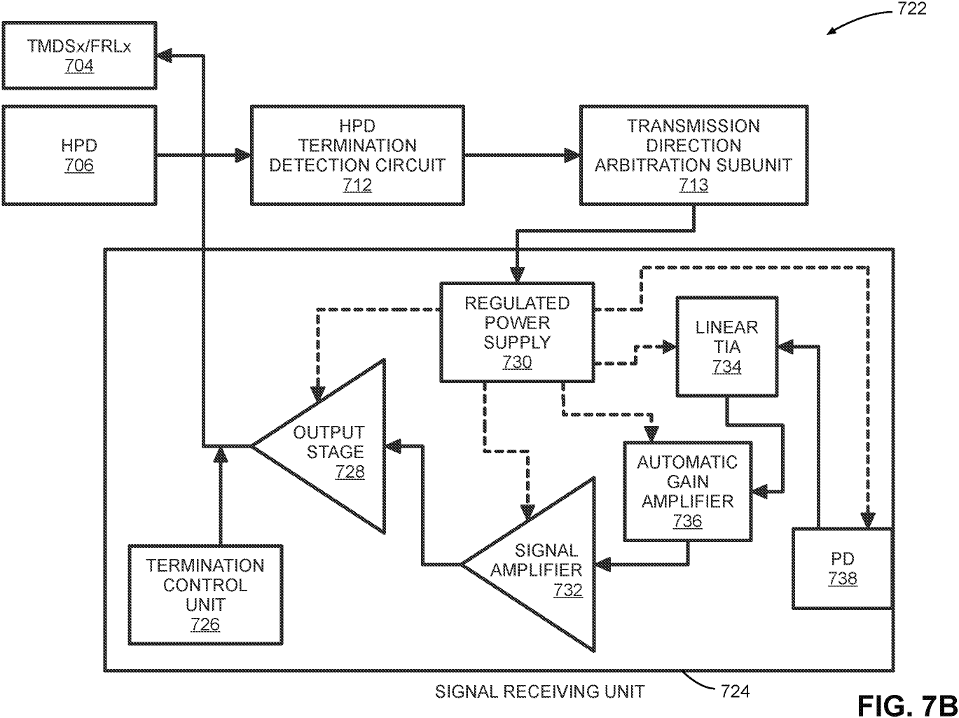

FIG. 7A is a block diagram depicting an embodiment of a signal transmitting unit interface 700. As depicted, signal transmitting unit interface 700 includes signal transmitting unit 702, TMDSx/FRLx interface 704, HPD interface 706, HPD termination detection circuit 712, and transmission direction arbitration subunit 713. Signal transmitting unit 702 further includes termination control unit 708, input stage 710, regulated power supply 716, signal amplifier 714, laser driving circuit 718, and laser 720. Signal transmitting interface 700 may be used as a High-Definition Multimedia Interface (HDMI) or a Digital Visual Interface (DVI) transmitting interface for an HDMI or DVI communication protocol.

Signal transmitting unit 702 may be similar to signal transmitting unit 202 or 304. TMDSx/FRLx interface 704 may be similar to high-speed electrical interface 206 or 306. HPD interface 706 may be similar to low-speed signal interface 208 or 308. A combination of HPD termination detection circuit 712 and transmission direction arbitration subunit 713 may be similar to low-speed signal monitoring unit 222 or 322. A combination of termination control unit 708, input stage 710, regulated power supply 716, signal amplifier 714, and laser driving circuit 718 may be similar to TX circuit 214 or 320.

In one aspect, HPD termination detection circuit 712 monitors one or more low-speed signals received at HPD interface 706. These low-speed signals may include one or more HDMI hot-plug detect (HPD) signals. Specifically, the HPD signals may be generated based on a termination resistance (e.g., a pull-up resistor or a pull-down resistor) at the associated communication signal source or communication signal sink. HPD termination detection circuit 712 may analyze the low-speed signals to determine whether the associated terminal (i.e., terminal 104 or 106) is connected to a communication signal source (e.g., communication signal source 108). If the terminal is connected to a communication signal source, then based on the analysis of HPD termination detection circuit 712, transmission direction arbitration subunit 713 activates regulated power supply 716 to supply power to input stage 710, signal amplifier 714, laser driving circuit 718, and laser 720. This is similar to low-speed signal monitoring unit 222 or 322 turning on signal transmitting unit 202 or 304, respectively. If the terminal is connected to a communication signal sink, then then based on the analysis of HPD termination detection circuit 712, transmission direction arbitration subunit 713 switches and maintains regulated power supply 716 in an off state. In this state, input stage 710, signal amplifier 714, laser driving circuit 718, and laser 720 are powered down, thereby saving power. This is similar to low-speed signal monitoring unit 222 or 322 turning off signal transmitting unit 202 or 304, respectively.

If the terminal is connected to a communication signal source, then TMDSx/FRLx interface 704 receives one or more high-speed electrical signals (i.e., HDMI TMDSx and/or FRLx signals) from the communication signal source (e.g., from communication signal source 108). Input stage 710 receives these high-speed electrical signals from TMDSx/FRLx interface 704, and performs preamplification and signal conditioning on the high-speed electrical signals. Termination control unit 708 is connected to the input of input stage 710. Termination control unit 708 provides appropriate signal termination so that signal transmitting unit 702 can share a common TMDSx/FRLx interface 704 with a corresponding signal receiving unit.

In one aspect, signal amplifier 714 amplifies an output of input stage 710, and transmits the amplified high-speed electrical signals to laser driving circuit 718. Laser driving circuit 718 can drive laser 720 using the amplified high-speed electrical signals, thereby converting the high-speed electrical signals into high-speed optical signals. The high-speed optical signals may be transmitted over an optical communication channel such as optical communication channel 112 or optical communication channel 114.

FIG. 7B is a block diagram depicting an embodiment of a signal receiving unit interface 722. As depicted, signal receiving unit interface 722 includes signal receiving unit 724, TMDSx/FRLx interface 704, HPD interface 706, HPD termination detection circuit 712, and transmission direction arbitration subunit 713. Signal transmitting unit 724 further includes termination control unit 726, photodetector PD 738, linear transimpedance amplifier 734, automatic gain amplifier 736, signal amplifier 732, regulated power supply 730, and output stage 728. Signal receiving interface 722 may be used as a High-Definition Multimedia Interface (HDMI) or a Digital Visual Interface (DVI) receiving interface for an HDMI or DVI communication protocol.

Signal receiving unit 724 may be similar to signal receiving unit 204 or 302. TMDSx/FRLx interface 704 may be similar to high-speed electrical interface 206 or 306. Low-HPD interface 706 may be similar to low-speed signal interface 208 or 308. A combination of HPD termination detection circuit 712 and transmission direction arbitration subunit 713 may be similar to low-speed signal monitoring unit 222 or 322. A combination of termination control unit 726 linear transimpedance amplifier 734, automatic gain amplifier 736, signal amplifier 732, regulated power supply 730, and output stage 728 may be similar to RX circuit 218 or 316.

In one aspect, HPD termination detection circuit 712 monitors one or more low-speed signals received at HPD interface 706. These low-speed signals may include one or more HDMI hot-plug detect (HPD) signals. Specifically, the HPD signals may be generated based on a termination resistance (e.g., a pull-up resistor or a pull-down resistor) at the associated communication signal source or communication signal sink. HPD termination detection circuit 712 may analyze the low-speed signals to determine whether the associated terminal (i.e., terminal 104 or 106) is connected to a communication signal sink (e.g., communication signal source 110). If the terminal is connected to a communication signal sink, then based on the analysis of HPD termination detection circuit 712, transmission direction arbitration subunit 713 activates regulated power supply 716 to supply power to photodetector 738, linear transimpedance amplifier 734, automatic gain amplifier 736, signal amplifier 732, and output stage 728. This is similar to low-speed signal monitoring unit 222 or 322 turning on signal receiving unit 204 or 302, respectively. If the terminal is connected to a communication signal source, then low-speed signal monitoring unit 712 switches and maintains regulated power supply 730 in an off state. In this state, photodetector 738, linear transimpedance amplifier 734, automatic gain amplifier 736, signal amplifier 732, and output stage 728 are powered down, thereby saving power. This is similar to low-speed signal monitoring unit 222 or 322 turning off signal receiving unit 204 or 302, respectively.

If the terminal is connected to a communication signal sink, then photodetector 738 receives one or more high-speed optical signals over an optical communication channel such as optical communication channel 112 or 114. These high-speed optical signals may be HDMI TMDSx/FRLx optical signals. Photodetector 738 converts the high-speed optical signals into receive high-speed electrical signals. Linear transimpedance amplifier 734 performs linear amplification on the receive high-speed electrical signals. Automatic gain amplifier 736 receives the linearly-amplified receive high-speed electrical signals and performs automatic gain compensation on these signals, to compensate for variable gain or signal loss over optical communication channel 112 or 114. Signal amplifier 732 performs further signal conditioning and amplification on the gain-compensated signals. Output stage 728 receives the output signals from signal amplifier 732, performs additional amplification and impedance matching on these signals, and transmits the signals as high-speed electrical signals to a communication signal sink (e.g., communication signal sink 110) via TMDSx/FRLx interface 704.

In one aspect, termination control unit 726 is connected to the output of output stage 728. Termination control unit 726 provides appropriate signal termination so that signal receiving unit 724 can share a common TMDSx/FRLx interface 704 with signal transmitting unit 702.

In one aspect, HPD interface 706 is used to detect a termination condition of an associated HPD signal from a communication signal source or a communication signal sink, so that transmission direction arbitration subunit 713 can judge a transmission direction of the associated high-speed (TMDSx/FRLx) signals according to the termination condition of the HPD signal. The termination condition of the HPD signal is that the termination resistor of the HPD signal is a pull-up resistor or a pull-down resistor.

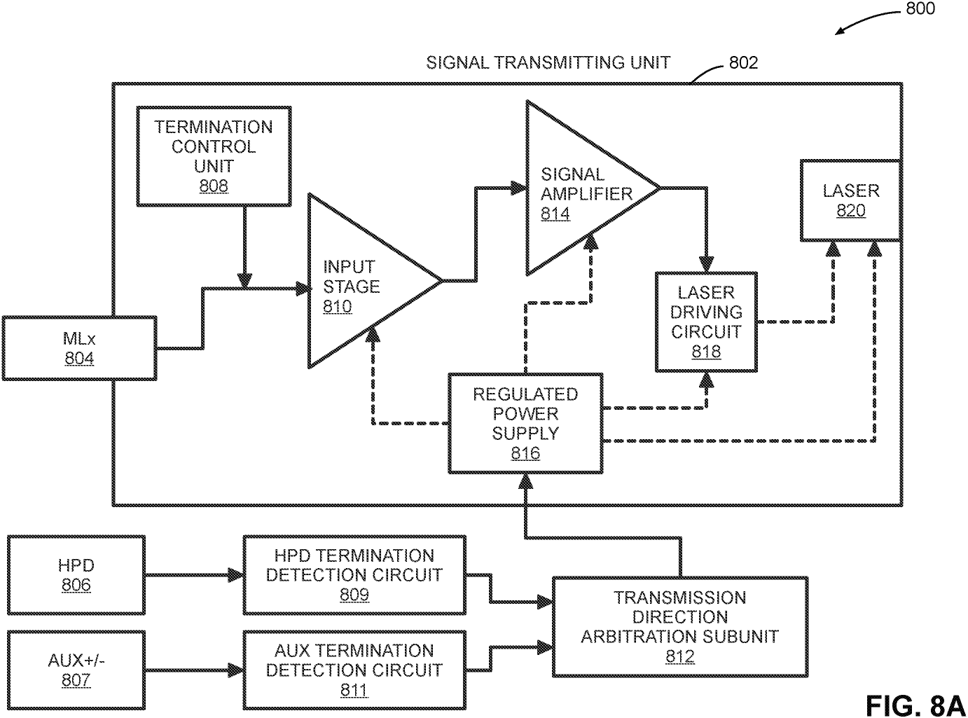

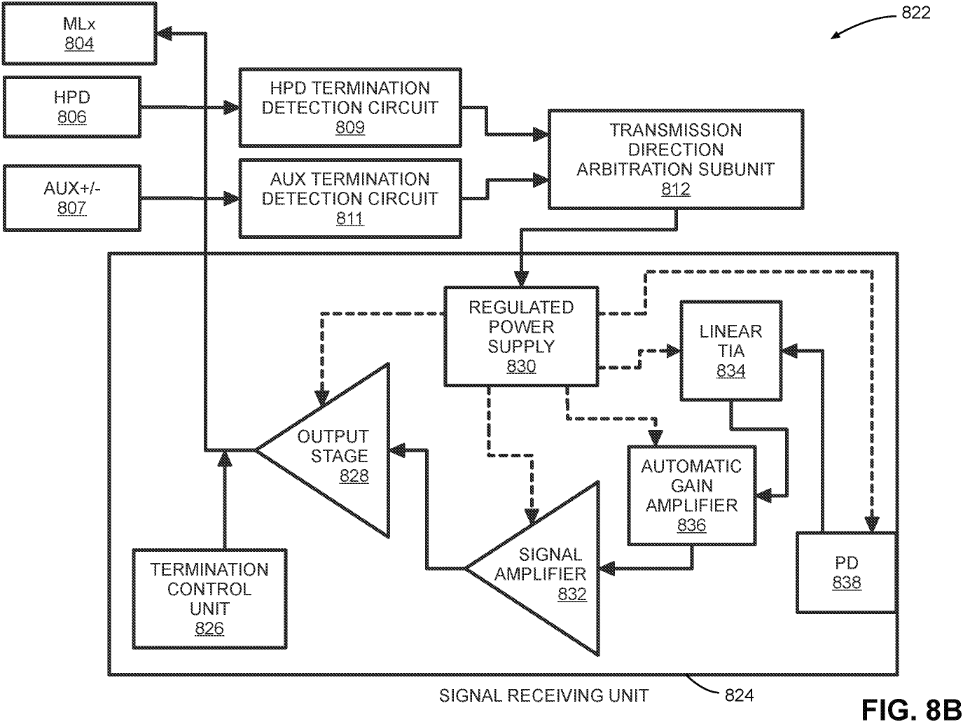

FIG. 8A is a block diagram depicting an embodiment of a signal transmitting unit interface 800. As depicted, signal transmitting unit interface 800 includes signal transmitting unit 802, MLx interface 804, HPD interface 806, AUX+/- interface 807, HPD termination detection circuit 809, AUX termination detection circuit 811, and transmission direction arbitration subunit 812. Signal transmitting unit 802 further includes termination control unit 808, input stage 810, regulated power supply 816, signal amplifier 814, laser driving circuit 818, and laser 820. Signal transmitting interface 800 may be used as a DisplayPort (DP) transmitting interface.

Signal transmitting unit 802 may be similar to signal transmitting unit 202 or 304. MLx interface 804 may be similar to high-speed electrical interface 206 or 306. A combination of HPD interface 806 and AUX+/- interface 807 may be similar to low-speed signal interface 208 or 308. A combination of protocol HPD termination detection circuit 809, AUX termination detection circuit 811, and transmission direction arbitration subunit 812 may be similar to low-speed signal monitoring unit 222 or 322. A combination of termination control unit 808, input stage 810, regulated power supply 816, signal amplifier 814, and laser driving circuit 818 may be similar to TX circuit 214 or 320.

In one aspect, HPD interface 806 is a DisplayPort hot-plug detect (HPD) interface that is configured to receive one or more low-speed signals (i.e., low-speed electrical signals) from a connected communication signal source (e.g., communication signal source 108) or communication signal sink (e.g., communication signal sink 110). Specifically, the HPD signals may be generated based on a termination resistance (e.g., a pull-up resistor or a pull-down resistor) at the associated communication signal source or communication signal sink. HPD termination detection circuit 809 may receive these low-speed signals from HPD interface 806. HPD termination detection circuit 809 may analyze these low-speed signals and determine a presence of a pull-up or pull-down resistor connected to HPD interface 806.

In one aspect, AUX termination detection circuit 811 receives one or more low-speed electrical signals from AUX+/- interface 807. AUX+/- interface 807 is a sideband interface that receives one or more AUX+/- sideband signals from a communication signal source (e.g., communication signal source 108) or a communication signal sink (e.g., communication signal sink 110). AUX termination detection circuit 811 may monitor a sideband signal or an AUX signal (i.e., an auxiliary signal), so that the transmission direction arbitration subunit 812 can judge the transmission direction of the signal according to the signal type.

Based on the analysis of HPD termination detection circuit 809 and AUX termination detection circuit 811, transmission direction arbitration subunit 812 can determine a transfer direction of the signal according to the transmission mode (i.e., whether a terminal associated with signal transmitting unit 802 is connected to a communication signal source or a communication signal sink, respectively).

If the terminal associated with signal transmitting unit 802 is connected to a communication signal source, then transmission direction arbitration subunit 812 activates regulated power supply 816 to supply power to input stage 810, signal amplifier 814, laser driving circuit 818, and laser 820. This is similar to low-speed signal monitoring unit 222 or 322 turning on signal transmitting unit 202 or 304, respectively. If the terminal is connected to a communication signal sink, then transmission direction arbitration subunit 812 switches and maintains regulated power supply 816 in an off state. In this state, input stage 810, signal amplifier 814, laser driving circuit 818, and laser 820 are powered down, thereby saving power. This is similar to low-speed signal monitoring unit 222 or 322 turning off signal transmitting unit 202 or 304, respectively.

If the terminal is connected to a communication signal source, then MLx interface 804 receives one or more high-speed electrical signals (i.e., DisplayPort signals) from the communication signal source (e.g., from communication signal source 108). Input stage 810 receives these high-speed electrical signals from high-speed electrical interface 804, and performs preamplification and signal conditioning on the high-speed electrical signals. Termination control unit 808 is connected to the input of input stage 810. Termination control unit 808 provides appropriate signal termination so that signal transmitting unit 802 can share a common MLx interface 804 with a corresponding signal receiving unit.

In one aspect, signal amplifier 814 amplifies an output of input stage 810, and transmits the amplified high-speed electrical signals to laser driving circuit 818. Laser driving circuit 818 can drive laser 820 using the amplified high-speed electrical signals, thereby converting the high-speed electrical signals into high-speed optical signals. The high-speed optical signals may be transmitted over an optical communication channel such as optical communication channel 112 or optical communication channel 114.

FIG. 8B is a block diagram depicting an embodiment of a signal receiving unit interface 822. As depicted, signal receiving unit interface 822 includes signal receiving unit 824, MLx interface 804, HPD interface 806, AUX+/- interface 807, HPD termination detection circuit 809, AUX termination detection circuit 811, and transmission direction arbitration subunit 812. Signal transmitting unit 824 further includes termination control unit 826, photodetector PD 838, linear transimpedance amplifier 834, automatic gain amplifier 836, signal amplifier 832, regulated power supply 830, and output stage 828. Signal receiving interface 824 may be used as a DisplayPort (DP) receiving interface.

Signal receiving unit 824 may be similar to signal receiving unit 204 or 302. MLx interface 804 may be similar to high-speed electrical interface 206 or 306. A combination of HPD interface 806 and AUX+/- interface 807, may be similar to low-speed signal interface 208 or 308. A combination of HPD termination detection circuit 809, AUX termination detection circuit 811, and transmission direction arbitration subunit 812 may be similar to low-speed signal monitoring unit 222 or 322. A combination of termination control unit 826, linear transimpedance amplifier 834, automatic gain amplifier 836, signal amplifier 832, regulated power supply 830, and output stage 828 may be similar to RX circuit 218 or 316.

In one aspect, HPD interface 806 is a DisplayPort hot-plug detect (HPD) interface that is configured to receive one or more low-speed signals (i.e., low-speed electrical signals) from a connected communication signal source (e.g., communication signal source 108) or communication signal sink (e.g., communication signal sink 110). Specifically, the HPD signals may be generated based on a termination resistance (e.g., a pull-up resistor or a pull-down resistor) at the associated communication signal source or communication signal sink. HPD termination detection circuit 809 may receive these low-speed signals from HPD interface 806. HPD termination detection circuit 809 may analyze these low-speed signals and determine a presence of a pull-up or pull-down resistor connected to HPD interface 806.

In one aspect, AUX termination detection circuit 811 receives one or more low-speed electrical signals from AUX+/- interface 807. AUX+/- interface 807 is a sideband interface that receives one or more AUX+/- sideband signals from a communication signal source (e.g., communication signal source 108) or a communication signal sink (e.g., communication signal sink 110). AUX termination detection circuit 811 may monitor a sideband signal or an AUX signal (i.e., an auxiliary signal), so that the transmission direction arbitration subunit 812 can judge the transmission direction of the signal according to the signal type.

Based on the analysis of HPD termination detection circuit 809 and AUX termination detection circuit 811, transmission direction arbitration subunit 812 can determine a transfer direction of the signal according to the transmission mode (i.e., whether a terminal associated with signal receiving unit 824 is connected to a communication signal source or a communication signal sink, respectively).

If the terminal is connected to a communication signal sink, transmission direction arbitration subunit 812 activates regulated power supply 830 to supply power to photodetector 838, linear transimpedance amplifier 834, automatic gain amplifier 836, signal amplifier 832, and output stage 828. This is similar to low-speed signal monitoring unit 222 or 322 turning on signal receiving unit 204 or 302, respectively. If the terminal is connected to a communication signal source, then transmission direction arbitration subunit 812 switches and maintains regulated power supply 830 in an off state. In this state, photodetector 838, linear transimpedance amplifier 834, automatic gain amplifier 836, signal amplifier 832, and output stage 828 are powered down, thereby saving power. This is similar to low-speed signal monitoring unit 222 or 322 turning off signal receiving unit 204 or 302, respectively.

If the terminal is connected to a communication signal sink, then photodetector 838 receives one or more high-speed optical signals over an optical communication channel such as optical communication channel 112 or 114. These high-speed optical signals may be DP optical signals. Photodetector 838 converts the high-speed optical signals into receive high-speed electrical signals. Linear transimpedance amplifier 834 performs linear amplification on the receive high-speed electrical signals. Automatic gain amplifier 836 receives the linearly-amplified receive high-speed electrical signals and performs automatic gain compensation on these signals, to compensate for variable gain or signal loss over optical communication channel 112 or 114. Signal amplifier 832 performs further signal conditioning and amplification on the gain-compensated signals. Output stage 828 receives the output signals from signal amplifier 832, performs additional amplification and impedance matching on these signals, and transmits the signals as high-speed electrical signals to a communication signal sink (e.g., communication signal sink 110) via MLx interface 804.

In one aspect, termination control unit 826 is connected to the output of output stage 828. Termination control unit 826 provides appropriate signal termination so that signal receiving unit 824 can share a common MLx interface 804 with signal transmitting unit 802.

In one aspect, a combination of signal transmitting unit interface 800 and signal receiving unit interface 822 implement a communication interface to communicate a DisplayPort communication protocol. In this implementation, the high-speed electrical interface is realized as MLx interface 804. The low-speed signal interface is realized as an HPD and AUX+/- interface (i.e., a combination of HPD interface 806 and AUX+/- interface 807). The corresponding low-speed signal monitoring subunit includes HPD termination detection circuit 809 and AUX termination detection circuit 811.

In one aspect, an input of HPD termination detection circuit 809 is connected with HPD interface 806. An output of HPD termination detection circuit 809 may be connected to transmission direction arbitration subunit 812. HPD termination detection circuit 809 may be configured to detect a termination of one or more HPD signals being communicated by the associated terminal. The termination condition of the HPD signal is that the termination resistor of the HPD signal is a pull-up resistor or a pull-down resistor.

In one aspect, an input of AUX termination detection circuit 811 is connected with AUX+/- interface 807. An output of AUX termination detection circuit 811 may be connected to transmission direction arbitration subunit 812. AUX termination detection circuit 811 may be configured to detect a termination of an associated AUX (Auxiliary) signal. The termination condition of the AUX signal is that the termination resistor of the AUX signal is a pull-up resistor or a pull-down resistor.

In one aspect, transmission direction arbitration subunit 812 is used to determine a transmission direction of the corresponding high-speed signals according to the termination conditions of the HPD signal and the AUX signal.

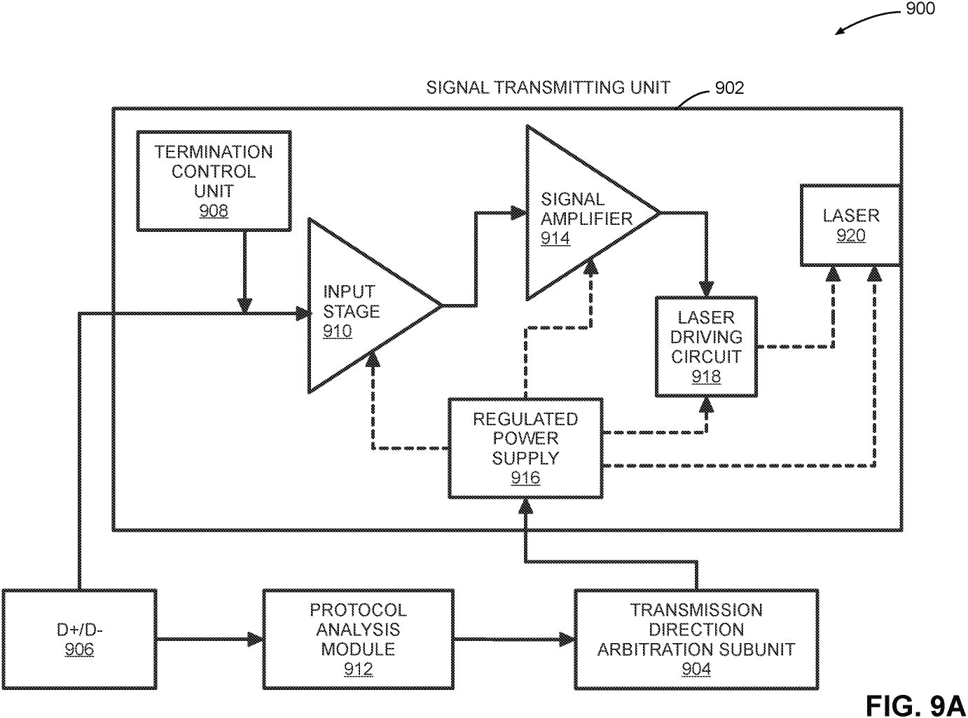

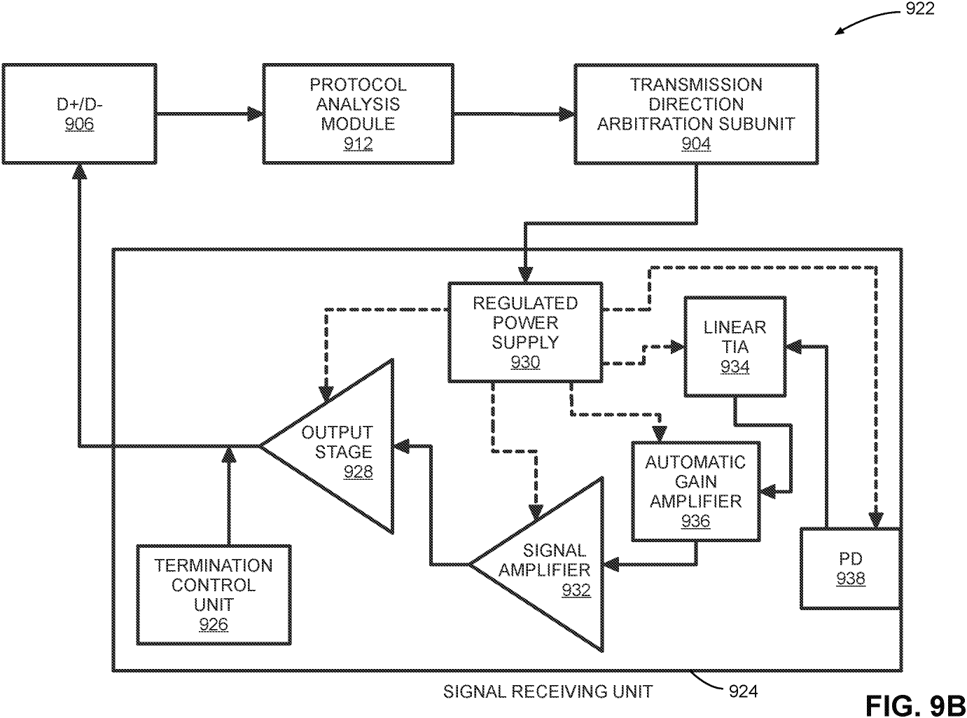

FIG. 9A is a block diagram depicting an embodiment of a signal transmitting unit interface 900. As depicted, signal transmitting unit interface 900 includes signal transmitting unit 902, D+/D- interface 906, protocol analysis module 912, and transmission direction arbitration subunit 904. Signal transmitting unit 902 further includes termination control unit 908, input stage 910, regulated power supply 916, signal amplifier 914, laser driving circuit 918, and laser 920. Signal transmitting interface 900 may be used as an interface to transmit a USB 2.0 or lower USB communication protocol.

Signal transmitting unit 902 may be similar to signal transmitting unit 202 or 304. D+/D- interface 906 may be similar to high-speed electrical interface 206 or 306. D+/D-interface 906 may also be similar to low-speed signal interface 208 or 308. A combination of protocol analysis module 912 and transmission direction arbitration subunit 904 may be similar to low-speed signal monitoring unit 222 or 322. A combination of termination control unit 908, input stage 910, regulated power supply 916, signal amplifier 914, and laser driving circuit 918 may be similar to TX circuit 214 or 320.

In one aspect, D+/D- interface 906 is a differential USB interface (i.e., a differential signal interface) that functions as a high-speed electrical interface and a low-speed signal interface. Protocol analysis module 912 (also referred to as a “protocol parsing module”) may receive one or more USB protocol data packets received at or transmitted by D+/D-interface 906. Protocol analysis module 912 may analyze (e.g., parse) these data packets and transmit the parsed results to transmission direction arbitration subunit 904. Transmission direction arbitration subunit 904 may use the parsed results to determine whether the associated terminal (i.e., terminal 104 or 106) is connected to a communication signal source (e.g., communication signal source 108). If the terminal is connected to a communication signal source, then transmission direction arbitration subunit 904 activates regulated power supply 916 to supply power to input stage 910, signal amplifier 914, laser driving circuit 918, and laser 920. This is similar to low-speed signal monitoring unit 222 or 322 turning on signal transmitting unit 202 or 304, respectively. If the terminal is connected to a communication signal sink, then transmission direction arbitration subunit 904 switches and maintains regulated power supply 916 in an off state. In this state, input stage 910, signal amplifier 14, laser driving circuit 918, and laser 920 are powered down, thereby saving power. This is similar to low-speed signal monitoring unit 222 or 322 turning off signal transmitting unit 202 or 304, respectively.

If the terminal is connected to a communication signal source at some time instant, then D+/D- interface 906 receives one or more high-speed electrical signals (i.e., USB 2.0 electrical signals, or electrical signals associated with a USB protocol earlier than USB 2.0) from the communication signal source (e.g., from communication signal source 108). In one aspect, for a USB 2.0 communication protocol, an associated communication direction is achieved by implementing a dynamic switching scheme. Input stage 910 receives these high-speed electrical signals from D+/D- interface 906, and performs preamplification and signal conditioning on the high-speed electrical signals. Termination control unit 908 is connected to the input of input stage 910. Termination control unit 908 provides appropriate signal termination so that signal transmitting unit 902 can share a common D+/D- interface 906 with a corresponding signal receiving unit.

In one aspect, signal amplifier 914 amplifies an output of input stage 910, and transmits the amplified high-speed electrical signals to laser driving circuit 918. Laser driving circuit 918 can drive laser 920 using the amplified high-speed electrical signals, thereby converting the high-speed electrical signals into high-speed optical signals. The high-speed optical signals may be transmitted over an optical communication channel such as optical communication channel 112 or optical communication channel 114.

FIG. 9B is a block diagram depicting an embodiment of a signal receiving unit interface 922. As depicted, signal receiving unit interface 922 includes signal receiving unit 924, 902, D+/D- interface 906, protocol analysis module 912, and transmission direction arbitration subunit 904. Signal transmitting unit 924 further includes termination control unit 926, photodetector PD 938, linear transimpedance amplifier 934, automatic gain amplifier 936, signal amplifier 932, regulated power supply 930, and output stage 928. Signal receiving interface 922 may be used as a receiving interface for a USB 2.0 or lower USB communication protocol .

Signal receiving unit 924 may be similar to signal receiving unit 204 or 302. D+/D- interface 906 may be similar to high-speed electrical interface 206 or 306. D+/D-interface 906 may also be similar to low-speed signal interface 208 or 308. A combination of protocol analysis module 912 and transmission direction arbitration subunit 904 may be similar to low-speed signal monitoring unit 222 or 322. A combination of termination control unit 926 linear transimpedance amplifier 934, automatic gain amplifier 936, signal amplifier 932, regulated power supply 930, and output stage 928 may be similar to RX circuit 218 or 316.

In one aspect, D+/D- interface 906 is a differential USB interface (i.e., a differential signal interface) that functions as a high-speed electrical interface and a low-speed signal interface. Protocol analysis module 912 (also referred to as a “protocol parsing module”) may receive one or more USB protocol data packets received at or transmitted by D+/D-interface 906. Protocol analysis module 912 may analyze (e.g., parse) these data packets and transmit the parsed results to transmission direction arbitration subunit 904. Transmission direction arbitration subunit 904 may use the parsed results to determine whether the associated terminal (i.e., terminal 104 or 106) is connected to a communication signal sink (e.g., communication signal source 110). If the terminal is connected to a communication signal sink, then transmission direction arbitration subunit 904 activates regulated power supply 916 to supply power to photodetector 938, linear transimpedance amplifier 934, automatic gain amplifier 936, signal amplifier 932, and output stage 928. This is similar to low-speed signal monitoring unit 222 or 322 turning on signal receiving unit 204 or 302, respectively. If the terminal is connected to a communication signal source, then transmission direction arbitration subunit 904 switches and maintains regulated power supply 930 in an off state. In this state, photodetector 938, linear transimpedance amplifier 934, automatic gain amplifier 936, signal amplifier 932, and output stage 928 are powered down, thereby saving power. This is similar to low-speed signal monitoring unit 222 or 322 turning off signal receiving unit 204 or 302, respectively.

If the terminal is connected to a communication signal sink at some instant, then photodetector 938 receives one or more high-speed optical signals over an optical communication channel such as optical communication channel 112 or 114. These high-speed optical signals may be USB optical signals corresponding to USB 2.0 communication signals or communication signals associated with a USB protocol earlier than USB 2.0. Photodetector 938 converts the high-speed optical signals into receive high-speed electrical signals. Linear transimpedance amplifier 934 performs linear amplification on the receive high-speed electrical signals. Automatic gain amplifier 936 receives the linearly-amplified receive high-speed electrical signals and performs automatic gain compensation on these signals, to compensate for variable gain or signal loss over optical communication channel 112 or 114. Signal amplifier 932 performs further signal conditioning and amplification on the gain-compensated signals. Output stage 928 receives the output signals from signal amplifier 932, performs additional amplification and impedance matching on these signals, and transmits the signals as high-speed electrical signals to a communication signal sink (e.g., communication signal sink 110) via D+/D- interface 906.

In one aspect, termination control unit 926 is connected to the output of output stage 928. Termination control unit 926 provides appropriate signal termination so that signal receiving unit 924 can share a common D+/D- interface 906 with signal transmitting unit 902.

In one aspect, a transmission protocol supported by a combination of signal transmitting unit interface 900 and signal receiving unit interface 922 is USB 2.0 and any USB protocol lower than USB 2.0. In one aspect, when the transmission protocol is USB 2.0 or the USB protocol lower than USB 2.0, the low-speed signal interface is included in D+/D- interface 906 (i.e., a differential signal interface).

In one aspect, low-speed signal monitoring subunit is protocol analysis module 912. Protocol parsing module 904 may be configured to parse the data packet transmitted by D+/D- interface 906, so that the transmission direction arbitration subunit 904 can determine the transmission direction of the signal according to the parsing result.

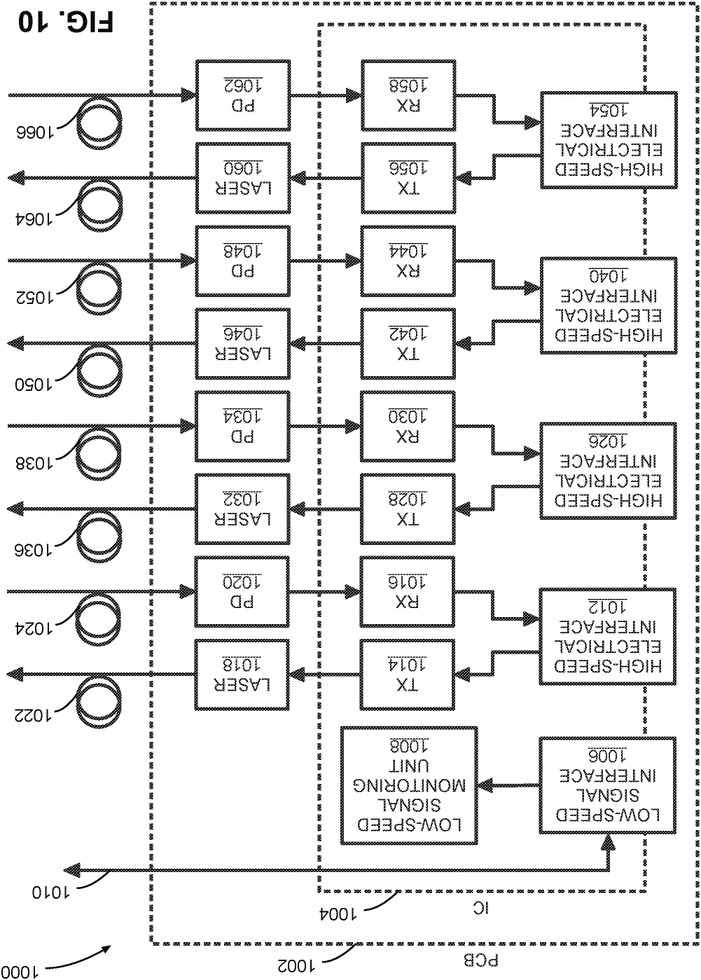

FIG. 10 is a block diagram depicting an embodiment of a terminal interface 1000. As depicted, terminal interface 1000 includes printed circuit board PCB 1002, electrical communication channel 1010, and optical communication channels 1022, 1024, 1036, 1038, 1050, 1052, 1064, and 1066. PCB 1002 further includes integrated circuit IC 1004, lasers 1018, 1032, 1046, and 1060, and photodetectors PD 1020, 1034, 1048, and 1062. IC 1004 further includes low speed signal interface 1006, low-speed signal monitoring unit 1008, high-speed electrical interfaces 1012, 1026, 1040, and 1054, transmit circuits (TX) 1014, 1028, 1042, and 1056, and receive circuits (RX) 1016, 1030, 1044, and 1058.

In one aspect, each of optical communication channel 1022, 1024, 1036, 1038, 1050, 1052, 1064, and 1066 is a unidirectional optical communication channel comprised of one or more optical fibers. Each of laser 1018, 1032, 1046, and 1060 may be a vertical-cavity surface-emitting laser (VCSEL), a laser diode, or any other kind of laser.

In one aspect, low speed signal interface 1006, low-speed signal monitoring unit 1008, high-speed electrical interfaces 1012, 1026, 1040, and 1054, transmit circuits (TX) 1014, 1028, 1042, and 1056, and receive circuits (RX) 1016, 1030, 1044, and 1058 are integrated onto IC 1004. Low speed signal interface 1006 and low-speed signal monitoring unit 1008 may be similar to low-speed signal interface 208/308 and low-speed signal monitoring unit 222/322, respectively. Each of high-speed electrical interface 1012, 1026, 1040, and 1054 may be similar to high-speed electrical interface 206 or 306; each of TX 1014, 1028, 1042, and 1056 may be similar to TX circuit 214 or 320; each of RX 1016, 1030, 1044, and 1058 may be similar to RX circuit 218 or 316; each of laser 1018, 1032, 1046, and 1060 may be similar to laser 216 or 318; each of PD 1020, 1034, 1048, and 1062 may be similar to PD 220 or 314; each of optical communication channel 1022, 1036, 1050, and 1064 may be similar to optical communication channel 112 or 114; each of optical communication channel 1024, 1038, 1052, and 1066 may be similar to optical communication channel 114 or 112, respectively.

Each set of a high-speed electrical interface (1012, 1026, 1040 or 1054) with the respective TX circuit (1014, 1028, 1042, or 1056), RX unit (1016, 1030, 1044, or 1058), laser (1018, 1032, 1046, or 1060), and PD (1020, 1034, 1048, or 1062) comprises a half-duplex combination of a high-speed electrical interface (e.g., high-speed electrical interface 206 or 306), a signal transmitting unit (e.g., signal transmitting unit 202 or 304) and a signal receiving unit (e.g., signal receiving unit 204 or 302). FIG. 10 depicts four such combinations that share a common low-speed signal interface and low-speed signal monitoring unit. The components integrated onto IC 1004 may function as terminal 104 or terminal 106. Low-speed signal interface 1006 may communicate one or more low-speed electrical signals received from a communication signal source or a communication signal sink to a corresponding terminal (i.e., terminal 106 or terminal 104, respectively), via electrical communication channel 1010. Low-speed signal interface 1006 may also receive one or more low-speed electrical signals received from the corresponding terminal via electrical communication channel 1010. Electrical communication channel 1010 functions as a bidirectional electrical communication channel.

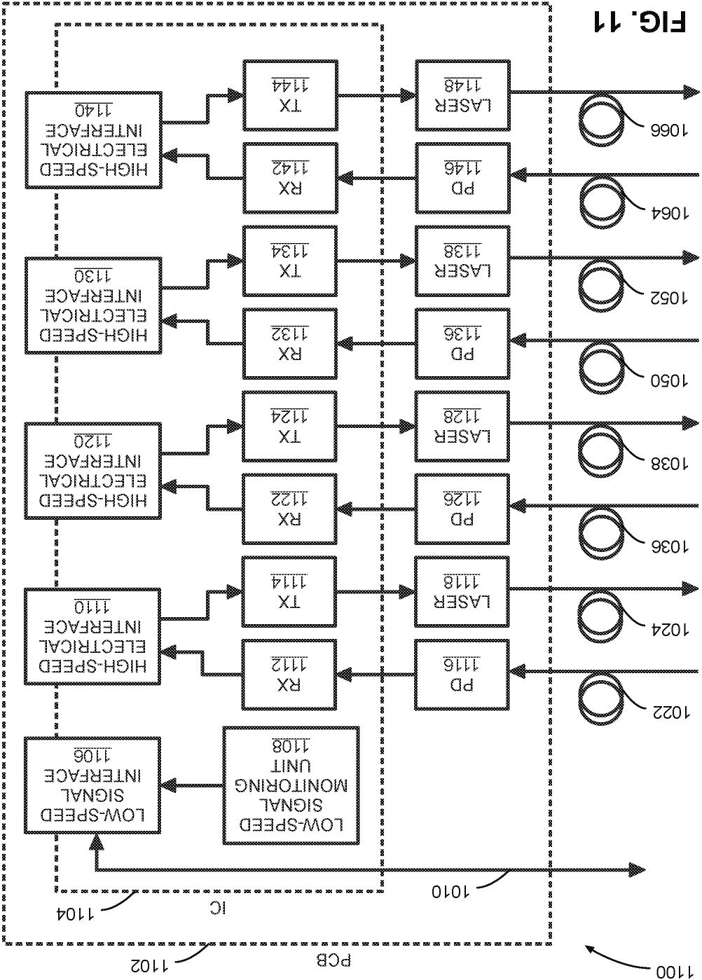

FIG. 11 is a block diagram depicting an embodiment of a terminal interface 1100. As depicted, terminal interface 1100 includes printed circuit board PCB 1102, electrical communication channel 1010, and optical communication channels 1022, 1024, 1036, 1038, 1050, 1052, 1064, and 1066. PCB 1102 further includes integrated circuit IC 1104, lasers 1118, 1128, 1138, and 1148, and photodetectors PD 1116, 1126, 1136, and 1146. IC 1104 further includes low speed signal interface 1106, low-speed signal monitoring unit 1108, high-speed electrical interfaces 1110, 1120, 1130, and 1140, transmit circuits (TX) 1114, 1124, 1134, and 1144, and receive circuits (RX) 1112, 1122, 1132, and 1142.

In one aspect, each of optical communication channel 1022, 1024, 1036, 1038, 1050, 1052, 1064, and 1066 is a unidirectional optical communication channel comprised of one or more optical fibers. Each of laser 1118, 1128, 1138, and 1148 may be a vertical-cavity surface-emitting laser (VCSEL), a laser diode, or any other kind of laser.

In one aspect, low speed signal interface 1106, low-speed signal monitoring unit 1108, high-speed electrical interfaces 1110, 1120, 1130, and 1140, transmit circuits (TX) 1114, 1124, 1134, and 1144, and receive circuits (RX) 1112, 1122, 1132, and 1142 are integrated onto IC 1104. Low speed signal interface 1106 and low-speed signal monitoring unit 1108 may be similar to low-speed signal interface 308/208 and low-speed signal monitoring unit 322/222, respectively. Each of high-speed electrical interface 1110, 1120, 1130, and 1140 may be similar to high-speed electrical interface 306 or 206; each of TX 1114, 1124, 1134, and 1144 may be similar to TX circuit 320 or 214; each of RX 1112, 1122, 1132, and 1142 may be similar to RX circuit 316 or 218; each of laser 1118, 1128, 1138, and 1148 may be similar to laser 318 or 216; each of PD 1116, 1126, 1136, and 1146 may be similar to PD 314 or 220; each of optical communication channel 1022, 1036, 1050, and 1064 may be similar to optical communication channel 112 or 114; each of optical communication channel 1024, 1038, 1052, and 1066 may be similar to optical communication channel 114 or 112, respectively.

Each set of a high-speed electrical interface (1110, 1120, 1130, or 1140) with the respective TX circuit (1114, 1124, 1134, or 1144), RX unit (1112, 1122, 1132, or 1142), laser (1118, 1128, 1138, or 1148), and PD (1116, 1126, 1136, or 1146) comprises a half-duplex combination of a high-speed electrical interface (e.g., high-speed electrical interface 306 or 206), a signal transmitting unit (e.g., signal transmitting unit 304 or 202) and a signal receiving unit (e.g., signal receiving unit 302 or 204). FIG. 11 depicts four such combinations that share a common low-speed signal interface and low-speed signal monitoring unit. The components integrated onto IC 1104 may function as terminal 106 or terminal 104. Low-speed signal interface 1106 may communicate one or more low-speed electrical signals received from a communication signal source or a communication signal sink to a corresponding terminal (i.e., terminal 104 or terminal 106, respectively), via electrical communication channel 1010. Low-speed signal interface 1106 may also receive one or more low-speed electrical signals received from the corresponding terminal via electrical communication channel 1010. Electrical communication channel 1010 functions as a bidirectional electrical communication channel.

In one aspect, a combination of PCB 1002, optical communication channels 1022 through 1066, and PCB 1102 may be assembled to construct an optical connector such as optical connector 102. In this connector, PCB 1002 may be similar to terminal 104, PCB 1102 may be similar to terminal 106, optical communication channels 1022, 1036, 1050, and 1064 are collectively similar to optical communication channel 112, and optical communication channels 1024, 1038, 1052, and 1066 are collectively similar to optical communication channel 114. In one aspect, each pair of optical communication channels that communicates in opposite directions (i.e., optical communication channel pairs 1022 and 1024, 1036 and 1038, 1050 and 1052, and 1064 and 1066) comprise an optical fiber group.

In general, an optical connector may have M such optical fiber groups. Such a connector may have N low-speed signal interfaces and N low-speed signal monitoring units in each terminal. In the example presented in FIGS. 10 and 11. M = 4 and N = 1.

In one aspect, PCB 1002 is constructed by packaging a terminal such as terminal 104 in the above system on a first PCB. PCB 1102 may be constructed by packaging a terminal such as terminal 106 on a second PCB. The two PCBs may be connected by one or more optical communication channels. For the optical connector constructed using PCBs 1002 and 1102, M is 4 and the value of N is 1. Also, low-speed signal interface 1006 is connected with low-speed signal interface 1106 via electrical communication channel 1010. While high-speed communication between the two terminals comprising optical connector 102 is performed using optical communication, the associated low-speed signals do not need to be connected by an optical fiber because of the low transmission speed. Electrical communication channel 1010 may be constructed using copper wire, while low-speed monitoring units 1008 and 1108 monitor the low-speed signal.

In one embodiment, transmitting circuit 214 and receiving circuit 218 are packaged together in one integrated circuit (chip). In this embodiment, transmitting circuit 304 and receiving circuit 302 are packaged together in one integrated circuit (chip). In another embodiment, each chip consists of four transmitting circuits, four receiving circuits and a low-speed signal monitoring unit, as depicted in FIGS. 10 and 11. The first chip and the second chip are mounted and wired on two PCB boards respectively or packaged and then mounted to obtain the PCB 1002 and the PCB 1102. All lasers (e.g., laser 216) and photodetectors (e.g., photodetector 220) may be directly mounted on the PCB board, and the laser of one terminal and the photodetector of the other terminal are lens-coupled and then connected by optical fiber (e.g., optical fiber 112 or 114), thus obtaining a high-speed photoelectric transmission cable (e.g., optical connector 102) which can dynamically change the transmission direction.

Different embodiments of optical connector 102 can be adapted to support different high-speed communication protocols. In one adaptation, the content monitored by low-speed signal monitoring unit 222 or 322 for example, is different. By changing the signal monitored by the associated low-speed monitoring unit, optical connector can be adapted for optical fiber transmission of most mainstream high-speed signals.

USB/LIGHTNING PROTOCOL OR DP ALT-MODE PROTOCOL OPERATION: When an optical cable constructed using terminal interfaces 1000 and 1100 is designed to support a USB/Lightning protocol, then components from signal transmitting unit interface 600 and signal receiving unit interface 622 may be used to construct the optical cable. For example, low-speed signal monitoring units 1008 and 1108 may be similar to a combination of protocol monitoring module 609, signal monitoring module 611, and transmission direction arbitration subunit 612. Such an optical connector (cable) can be used as a USB/ Lightning protocol full-function active optical cable, and the cable does not need to be connected such that one terminal can be connected only to a communication signal source and the other terminal can be connected only to a communication signal sink. Either terminal can be connected to a communication signal source, with the other terminal being connected to a communication signal sink. In this sense, optical connector 102 is connection-agnostic.

In one aspect, low-speed signal monitoring unit 1008 or 1108 monitors a CC1/CC2 low-speed signal interface of a USB/ lightning protocol. By analyzing the Power Delivery protocol, low-speed signal monitoring unit 1008 or 1108 can determine whether the system is in a DisplayPort Alt-mode mode or a conventional USB/Lightning protocol communication mode. When in USB/Lightning protocol communication mode, two high-speed electrical interfaces in each of IC 1004 and 1104 are configured as transmitting circuits TX and the other two high-speed electrical interfaces are configured as receiving circuits RX. For example, any pair of high-speed electrical interfaces from high-speed electrical interfaces 1012, 1026, 1130, and 1140 can be configured as transmitting circuits, while any pair of high-speed electrical interfaces from high-speed electrical interfaces 1040, 1054, 1110, and 1120 can be configured as receiving circuits. These high-speed circuits can support USB3.0, USB3.1, USB3.2, USB4 and Lightning-related protocols.

On the other hand, if the Power Delivery protocol monitoring result shows that the system has entered the DisplayPort Alt-mode mode, at this time, four high-speed electrical interfaces of one terminal are all configured as transmitting circuits TX, and the four high-speed electrical interfaces of the other terminal are all configured as receiving circuits RX. For example, if IC 1004 is connected to a DisplayPort signal source and if IC 1104 is connected to a DisplayPort signal sink, then a pull-down resistance of an associated HPD signal or AUX (SBU1, SBU2) signals can be detected based on the DisplayPort protocol. In this connection configuration, high-speed electrical interfaces 1012, 1026, 1040, and 1054 are configured as TX circuits. At the same time, high-speed electrical interfaces 1110, 1120, 1130, and 1140 are configured as RX circuits. Combining the architectures presented in FIGS. 6A, 6B, 10, and 11, can help realize full-function USB/Lightning active optical cable, which makes up the market gap for this kind of active optical cable.

HDMI/DVI PROTOCOL OPERATION: When an optical cable constructed using terminal interfaces 1000 and 1100 is designed to support a HDMI/DVI protocol, then components from signal transmitting unit interface 700, and signal receiving unit interface 722 may be used to construct the optical cable. For example, low-speed signal monitoring units 1008 and 1108 may be similar to a combination of HPD termination detection circuit 712 and transmission direction arbitration subunit 713. Such an optical connector (cable) can be used as a HDMI/DVI active optical cable, and the cable does not need to be connected such that one terminal can be connected only to a communication signal source and the other terminal can be connected only to a communication signal sink. Either terminal can be connected to a communication signal source, with the other terminal being connected to a communication signal sink. In this sense, optical connector 102 is connection-agnostic.

In one aspect, low-speed signal monitoring unit 1008 or 1108 determines whether the associated connector (i.e., the signal connector in which the low-speed signal monitoring unit is included) is a transmitting circuit TX or a receiving circuit RX. This determination is done by detecting whether the termination resistance of the HPD signal of HDMI/DVI protocol is pulled up or down. Depending on the termination resistance of the HPD signal being pulled up or pulled down, the corresponding connector is configured to be a TX circuit or an RX circuit. Combining the architectures presented in FIGS. 7A, 7B, 10, and 11, can help realize full-function HDMI/DVI active optical cable. Such a cable can adaptively change the transmission direction, which solves the problem that the HDMI/DVI active optical cable needs to distinguish the direction of the source end and the direction of the display end. This cable behaves like a direction-agnostic copper cable, which further reduces the possible risk of wrong insertion and enhances the usability of the HDMI/DVI active optical cable.

DP PROTOCOL OPERATION: When an optical cable constructed using terminal interfaces 1000 and 1100 is designed to support a DisplayPort protocol, then components from signal transmitting unit interface 800, and signal receiving unit interface 822, may be used to construct the optical cable. For example, low-speed signal monitoring units 1008 and 1108 may be similar to a combination of HPD termination detection circuit 809, AUX termination detection circuit 811, and transmission direction arbitration subunit 812. Such an optical connector (cable) can be used as a DisplayPort protocol full-function active optical cable, and the cable does not need to be connected such that one terminal can be connected only to a communication signal source and the other terminal can be connected only to a communication signal sink. Either terminal can be connected to a communication signal source, with the other terminal being connected to a communication signal sink. In this sense, optical connector 102 is connection-agnostic.

In one aspect, low-speed signal monitoring unit 1008 or determines whether the associated connector is a transmitting circuit TX or a receiving circuit RX by detecting the pull-down of HPD signal and AUX signal of a DisplayPort protocol. Such a cable can adaptively change the transmission direction, which solves the problem that the direction of the DisplayPort active optical cable needs to be distinguished between the source end and the display end. This cable behaves like a direction-agnostic copper cable, thereby reducing the possible risk caused by wrong insertion, and enhances the usability of the DisplayPort active optical cable.

USB 2.0 OR EARLIER PROTOCOL OPERATION: When an optical cable constructed using terminal interfaces 1000 and 1100 is designed to support a USB 2.0 protocol or a USB protocol earlier than USB 2.0, then components from signal transmitting unit interface 900 and signal receiving unit interface 922 may be used to construct the optical cable. For example, low-speed signal monitoring units 1008 and 1108 may be similar to a combination of protocol analysis module 912 and transmission direction arbitration subunit 904. In such a cable the number of high-speed channels (that is, the number of high-speed electrical interfaces in each connector) can be reduced to one, and an active optical cable of USB 2.0 and lower can be realized.

In one aspect, the low-speed signal monitoring unit of such a cable directly monitors the USB protocol of USB 2.0 and lower to obtain the transmission discovery of the current signal. The USB protocol of USB 2.0 and lower version adopts half-duplex communication, and its communication consists of three stages: token, data and handshake. According to the analysis of USB packet, information about a current stage can be obtained, whether it is the host output information or the host receiving information. This provides information on the transmission direction of the current signal. Based on this monitoring information, the transmission direction can be dynamically switched. Combining the architectures presented in FIGS. 8A, 8B, 10, and 11, can help realize an optical fiber-based, half-duplex transmission of USB 2.0 and lower USB protocols. Similar other half-duplex communication modes can also use variations of the embodiments described herein for optical fiber transmission.

For other directional variable or half-duplex active optical cable implementations, the number of high-speed channels can be increased or decreased on the basis of FIGS. 10 and 11 as required.

In the prior art, due to the unidirectionality of optical fiber signal transmission, using optical fiber(s) to transmit high-speed electrical signals has the problems that the transmission direction cannot be changed after the cable is manufactured. In other words, the connectivity of each terminal is fixed (i.e., communication signal source or communication signal sink). Consequently, bidirectional communication cannot be realized without changing the electrical interface. The embodiments described herein (e.g., optical connector 102) implement a high-speed photoelectric transmission system and cable that can dynamically change the transmission direction, and is agnostic to connectivity. In a concrete implementation of different high-speed communication protocols, the signal transmission direction can be switched by monitoring to related low-speed signals, and in half-duplex communication, the dynamic signal transmission direction can be switched by monitoring to high-speed signal protocols.

Optical connector 102 is suitable for optical fiber transmission of high-speed and low-speed audio and video signals such as HDMI, DisplayPort and DVI, high-speed and low-speed signals of USB (super speed, USB4) and Lightning protocol, and various other half-duplex communication signals. The active optical cable (i.e., optical connector 102) can solve the problems that the active optical cable currently used for display needs to distinguish signal sources from displays and cables need to distinguish directions. Optical connector 102, in various embodiments, can realize the full-function active optical cable of USB and Lightning, and can adaptively switch the optical fiber communication direction by analyzing related low-speed signals, implement the switching between the USB/Lightning high-speed communication mode and the DisplayPort alt-mode, and can keep the direction independence of cables. In addition, high-speed half-duplex communication can also be transmitted by using optical fibers using various embodiments of optical connector 102.

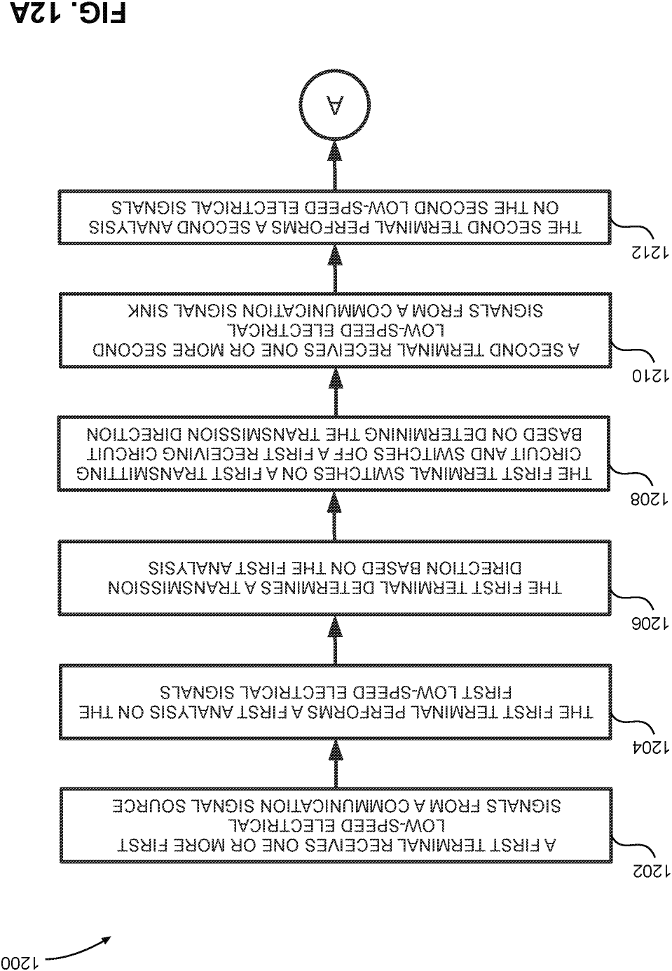

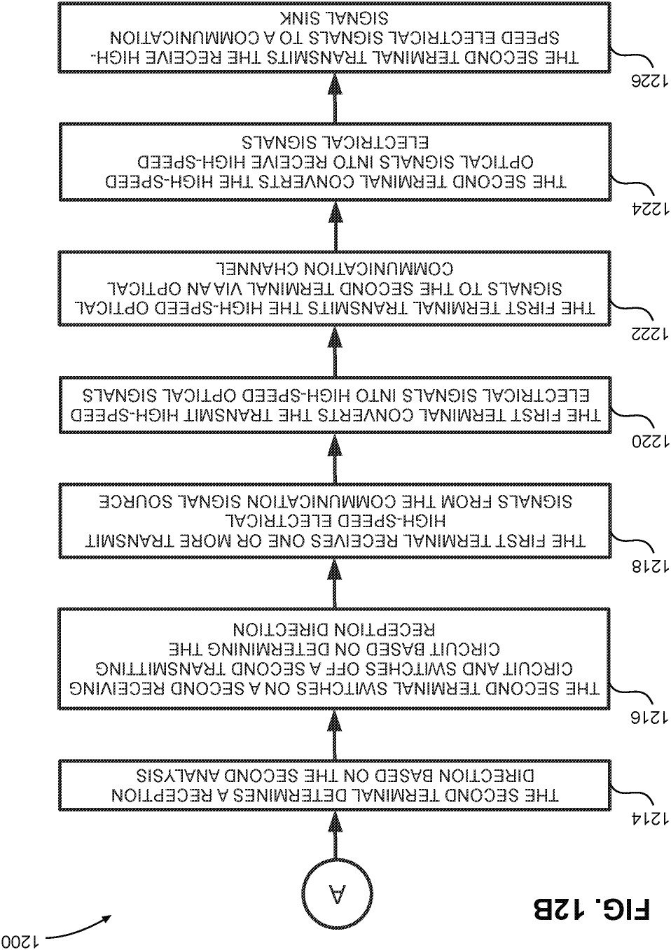

FIGS. 12A and 12B are flow diagrams depicting a method 1200 to transmit high-speed electrical signals from a communication signal source to a communication signal sink via an optical communication channel.

Method 1200 may include a first terminal receiving one or more first low-speed electrical signals from a communication signal source (1202). For example, terminal 104 may receive one or more low-speed electrical signals from communication signal source 108 via low-speed signal interface 208. Examples of such low-speed electrical signals include low-speed signals associated with a USB/Lightning protocol, an HDMI/DVI protocol, a DisplayPort protocol, or a USB 2.0 protocol or earlier USB protocols. In one aspect, the first terminal is agnostic to a transmission direction associated with the communication signal source. In other words, the first terminal does not have a priori knowledge of the connection being to a communication signal source or a communication signal sink before the connection is made.

Method 1200 may include the first terminal performing a first analysis on the first low-speed electrical signals (1204). For example, low-speed signal monitoring unit 222 may analyze the low-speed electrical signals received by terminal 104 via low-speed signal interface 208, from communication signal source 108.

Method 1200 may include the first terminal determining the transmission direction based on the first analysis (1206). For example, low-speed signal monitoring unit 222 may determine the transmission direction (e.g., determine that terminal 104 is connected to communication signal source 108) based on the first analysis.

Method 1200 may include the first terminal switching on a first transmitting circuit and switching off a first receiving circuit based on determining the transmission direction (1208). For example, low-speed signal monitoring unit 222 may turn on TX circuit 214, and turn off RX circuit 218 based on determining the transmission direction (i.e., based on determining that terminal 104 is connected to communication signal source 108).

Method 1200 may include a second terminal receiving one or more first low-speed electrical signals from a communication signal sink (1210). For example, terminal 106 may receive one or more low-speed electrical signals from communication signal sink 110 via low-speed signal interface 308. These low-speed electrical signals may correspond to the communication protocols described earlier. In one aspect, the second terminal is agnostic to a reception direction associated with the communication signal sink. In other words, the second terminal does not have a priori knowledge of the connection being to a communication signal source or a communication signal sink before the connection is made.

Method 1200 may include the second terminal performing a second analysis on the second low-speed electrical signals (1212). For example, low-speed signal monitoring unit 322 may analyze the low-speed electrical signals received by terminal 106 via low-speed signal interface 308, from communication signal sink 110.

Method 1200 may include the second terminal determining the reception direction based on the second analysis (1214). For example, low-speed signal monitoring unit 322 may determine the reception direction (e.g., determine that terminal 106 is connected to communication signal sink 110) based on the second analysis.

Method 1200 may include the second terminal switching on a second receiving circuit and switching off a second transmitting circuit based on determining the reception direction (1216). For example, low-speed signal monitoring unit 322 may turn on RX circuit 316, and turn off TX circuit 320 based on determining the reception direction (i.e., based on determining that terminal 106 is connected to communication signal source 110).

Method 1200 may include the first terminal receiving one or more transmit high-speed electrical signals from the communication signal source (1218). For example, terminal 104 may receive one or more transmit high-speed electrical signals from communication signal source 108 via high-speed electrical interface 206. These high-speed electrical signals may be high-speed signals associated with the protocols described earlier.

Method 1200 may include converting the transmit high-speed electrical signals into high-speed optical signals (1220). For example, signal transmitting unit 202 may convert the high-speed electrical signals received via high-speed electrical interface 206 to high-speed optical signals.

Method 1200 may include the first terminal transmitting the high-speed optical signals to the second terminal via an optical communication channel (1222). For example, terminal 104 (specifically, signal transmitting unit 202) may transmit the high-speed optical signals to terminal 106 via optical communication channel 112.

Method 1200 may include the second terminal converting the high-speed optical signals into receive high-speed electrical signals (1224). For example, signal receiving unit 302 in terminal 106 may convert the high-speed optical signals into receive high-speed electrical signals.

Method 1200 may include the second terminal transmitting the receive high-speed electrical signals to a communication signal sink (1226). For example, terminal 106 may transmit the output of signal receiving unit 302 to communication signal sink 110 via high-speed electrical interface 306.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A USB/Thunderbolt connector comprising:
a first terminal comprising:
a first USB/Thunderbolt high-speed electrical interface;
a first USB/Thunderbolt signal analysis unit configured to receive one or more first USB/Thunderbolt low-speed signals, analyze the first USB/Thunderbolt low-speed signals, and determine if the first terminal is connected to one of: a USB/Thunderbolt signal source or a USB/Thunderbolt signal sink, based on the analysis of the first USB/Thunderbolt low-speed signals;
a first signal transmitting unit electrically connected to the first USB/Thunderbolt high-speed electrical interface; and
a first signal receiving unit electrically connected to the first USB/Thunderbolt high-speed electrical interface;
a second terminal comprising:
a second USB/Thunderbolt high-speed electrical interface;
a second USB/Thunderbolt signal analysis unit configured to receive one or more second USB/Thunderbolt low-speed signals, analyze the second USB/Thunderbolt low-speed signals, and determine if the second terminal is connected to the other of: the USB/Thunderbolt signal source or the USB/Thunderbolt signal sink, based on the analysis of the second USB/Thunderbolt low-speed signals;
a second signal transmitting unit electrically connected to the second USB/Thunderbolt high-speed electrical interface; and
a second signal receiving unit electrically connected to the second USB/Thunderbolt high-speed electrical interface;
a first optical communication channel connecting an output of the first signal transmitting unit to an input of the second signal receiving unit, wherein the first signal transmitting unit facilitates electro-optical communication between the first USB/Thunderbolt high-speed electrical interface and the second signal receiving unit via the first optical communication channel; and
a second optical communication channel connecting an output of the second signal transmitting unit to an input of the first signal receiving unit, wherein the second signal transmitting unit facilitates electro-optical communication between the second USB/Thunderbolt high-speed electrical interface and the first signal receiving unit via the second optical communication channel.

2. The USB/Thunderbolt connector of claim 1, wherein the first USB/Thunderbolt signal analysis unit comprises:
a USB channel configuration interface configured to receive one or more low-speed USB/Thunderbolt channel configuration signals from the USB/Thunderbolt signal source or the USB/Thunderbolt signal sink;
a USB protocol monitoring module configured to analyze a power delivery protocol in the USB/Thunderbolt channel configuration signals received from the USB channel configuration interface, to determine whether the low-speed USB/Thunderbolt channel configuration signals correspond to a DisplayPort Alt mode or a USB/Thunderbolt protocol communication mode;
a USB sideband interface configured to receive one or more USB/Thunderbolt sideband signals from the USB/Thunderbolt signal source or the USB/Thunderbolt signal sink;
a USB sideband signal monitoring module configured to monitor the USB/Thunderbolt sideband signals to determine a transmission or reception direction associated with the USB/Thunderbolt sideband signals; and
a transmission direction arbitration subunit configured to determine if the first terminal is connected to the USB/Thunderbolt signal source or the USB/Thunderbolt signal sink and determine a transmission or reception direction associated with the USB/Thunderbolt connection, based on the power delivery protocol analysis and the monitoring.

3. The USB/Thunderbolt connector of claim 1, wherein when the first terminal is connected to the USB/Thunderbolt signal source and the second terminal is connected to the USB/Thunderbolt signal sink, the USB/Thunderbolt signal analysis unit determines that the first terminal is connected to the USB/Thunderbolt signal source, the first USB/Thunderbolt signal analysis unit determines a transmission direction associated with the connection of the first terminal to the USB/Thunderbolt signal source, the first USB/Thunderbolt signal analysis unit turns on the first signal transmitting unit and turns off the first signal receiving unit, the second USB/Thunderbolt signal analysis unit determines that the second terminal is connected to the USB/Thunderbolt signal sink, the second USB/Thunderbolt signal analysis unit determines a reception direction associated with the connection of the second terminal to the USB/Thunderbolt signal sink, and the second USB/Thunderbolt signal analysis unit turns on the second signal receiving unit and turns off the second signal transmitting unit.

4. The USB/Thunderbolt connector of claim 3, wherein the first signal transmitting unit receives one or more transmit USB or Thunderbolt electrical signals from the USB/Thunderbolt signal source via the first USB/Thunderbolt high-speed electrical interface, converts the transmit USB or Thunderbolt electrical signals into corresponding USB or Thunderbolt optical signals, and transmits the USB or Thunderbolt optical signals to the second signal receiving unit via the first optical communication channel, and wherein the second signal transmitting unit receives the USB or Thunderbolt optical signals, converts the USB or Thunderbolt optical signals into receive USB or Thunderbolt electrical signals, and transmits the receive USB or Thunderbolt signals to the USB/Thunderbolt signal source via the second USB/Thunderbolt high-speed electrical interface.

5. The USB/Thunderbolt connector of claim 1, wherein the first signal transmitting unit includes:
a termination control unit configured to provide a termination resistance matching with the first signal receiving unit;
at least one amplification stage configured to amplify a transmit electrical signal received via the corresponding USB/Thunderbolt high-speed electrical interface;
a laser driving circuit configured to condition the amplified transmit electrical signal;
a laser driven by the laser driving circuit using the conditioned transmit electrical signal, wherein the laser converts the conditioned transmit electrical signal into a transmit optical signal; and
a regulated power supply configured to supply electrical power to the amplification stage, the laser driving circuit, and the laser.

6. The USB/Thunderbolt connector of claim 1, wherein the first signal receiving unit includes:
a termination control unit configured to provide a termination resistance matching with the first signal transmitting unit;
a photodetector configured to receive a receive optical signal via an associated optical communication channel, and convert the receive optical signal into a receive electrical signal;
at least one amplification stage configured to amplify the receive electrical signal; and
a regulated power supply configured to supply electrical power to the photodetector and the amplification stage.

7. The USB/Thunderbolt connector of claim 1, wherein the first signal transmitting unit and the first signal receiving unit are commonly connected to the first high-speed USB/Thunderbolt electrical interface via a current-mode logic (CML) interface or a voltage-mode logic (VML) interface.

8. The USB/Thunderbolt connector of claim 1, wherein the first signal transmitting unit and the first signal receiving unit are commonly connected to the first high-speed USB/Thunderbolt electrical interface via a high-speed switch.

9. The USB/Thunderbolt connector of claim 1, wherein the second signal transmitting unit and the second signal receiving unit are commonly connected to the second high-speed USB/Thunderbolt electrical interface via a current-mode logic (CML) interface or a voltage-mode logic (VML) interface.

10. The USB/Thunderbolt connector of claim 1, wherein the second signal transmitting unit and the second signal receiving unit are commonly connected to the second high-speed USB/Thunderbolt electrical interface via a high-speed switch.

11. The USB/Thunderbolt connector of claim 1, wherein the first terminal includes a plurality of pairs of transceiver modules, wherein each transceiver module is comprised of a signal transmitting unit and a signal receiving unit.

12. The USB/Thunderbolt connector of claim 11, wherein each transceiver module is a half-duplex transceiver module.

13. The USB/Thunderbolt connector of claim 11, wherein the first terminal includes a plurality of USB/Thunderbolt signal analysis units, wherein a number of USB/Thunderbolt signal analysis units is equal to a number of pairs of transceiver modules.

14. A DisplayPort connector comprising:
a first terminal comprising:
a first DisplayPort high-speed electrical interface;
a first DisplayPort signal analysis unit configured to receive one or more first DisplayPort low-speed signals, analyze the first DisplayPort low-speed signals, and determine if the first terminal is connected to one of: a DisplayPort signal source or a DisplayPort signal sink, based on the analysis of the first DisplayPort low-speed signals;
a first signal transmitting unit electrically connected to the first DisplayPort high-speed electrical interface; and
a first signal receiving unit electrically connected to the first DisplayPort high-speed electrical interface;
a second terminal comprising:
a second DisplayPort high-speed electrical interface;
a second DisplayPort signal analysis unit configured to receive one or more second DisplayPort low-speed signals, analyze the second DisplayPort low-speed signals, and determine if the second terminal is connected to the other of: the DisplayPort signal source or the DisplayPort signal sink, based on the analysis of the second DisplayPort low-speed signals;
a second signal transmitting unit electrically connected to the second DisplayPort high-speed electrical interface; and
a second signal receiving unit electrically connected to the second DisplayPort high-speed electrical interface;
a first optical communication channel connecting an output of the first signal transmitting unit to an input of the second signal receiving unit, wherein the first signal transmitting unit facilitates electro-optical communication between the first DisplayPort high-speed electrical interface and the second signal receiving unit via the first optical communication channel; and
a second optical communication channel connecting an output of the second signal transmitting unit to an input of the first signal receiving unit, wherein the second signal transmitting unit facilitates electro-optical communication between the second DisplayPort high-speed electrical interface and the first signal receiving unit via the second optical communication channel.

15. The DisplayPort connector of claim 14, wherein the first DisplayPort signal analysis unit comprises:
a hot-plug detect interface configured to receive one or more low-speed hot-plug detect signals from the DisplayPort signal source or the DisplayPort signal sink;
an HPD termination detection circuit configured to analyze one or more hot-plug detect signals received from the DisplayPort signal source or the DisplayPort signal sink to determine a presence of a pull-up resistor or a pull-down resistor;
an auxiliary signal interface configured to receive one or more auxiliary sideband signals from the DisplayPort signal source or the DisplayPort signal sink;
an auxiliary termination detection circuit configured to monitor the one or more auxiliary sideband signals; and
a transmission direction arbitration subunit configured to determine if the first terminal is connected to the DisplayPort signal source or the DisplayPort signal sink, and determine a transmission or reception direction associated with the DisplayPort connection, based on the hot-plug detect signal analysis and the monitoring.

16. The DisplayPort connector of claim 14, wherein when the first terminal is connected to the DisplayPort signal source and the second terminal is connected to the DisplayPort signal sink, the DisplayPort signal analysis unit determines that the first terminal is connected to the DisplayPort signal source, the first DisplayPort signal analysis unit determines a transmission direction associated with the connection of the first terminal to the DisplayPort signal source, the first DisplayPort signal analysis unit turns on the first signal transmitting unit and turns off the first signal receiving unit, the second DisplayPort signal analysis unit determines that the second terminal is connected to the DisplayPort signal sink, the second DisplayPort signal analysis unit determines a reception direction associated with the connection of the second terminal to the DisplayPort signal sink, and the second DisplayPort signal analysis unit turns on the second signal receiving unit and turns off the second signal transmitting unit.

17. The DisplayPort connector of claim 16, wherein the first signal transmitting unit receives one or more transmit DisplayPort electrical signals from the DisplayPort signal source via the first DisplayPort high-speed electrical interface, converts the transmit DisplayPort electrical signals into corresponding DisplayPort optical signals, and transmits the DisplayPort optical signals to the second signal receiving unit via the first optical communication channel, and wherein the second signal transmitting unit receives the DisplayPort optical signals, converts the DisplayPort optical signals into receive DisplayPort electrical signals, and transmits the receive DisplayPort signals to the DisplayPort signal source via the second DisplayPort high-speed electrical interface.

18. The DisplayPort connector of claim 14, wherein the first signal transmitting unit includes:
a termination control unit configured to provide a termination resistance matching with the first signal receiving unit;
at least one amplification stage configured to amplify a transmit electrical signal received via the corresponding DisplayPort high-speed electrical interface;
a laser driving circuit configured to condition the amplified transmit electrical signal;
a laser driven by the laser driving circuit using the conditioned transmit electrical signal, wherein the laser converts the conditioned transmit electrical signal into a transmit optical signal; and
a regulated power supply configured to supply electrical power to the amplification stage, the laser driving circuit, and the laser.

19. The DisplayPort connector of claim 14, wherein the first signal receiving unit includes:
a termination control unit configured to provide a termination resistance matching with the first signal transmitting unit;
a photodetector configured to receive a receive optical signal via an associated optical communication channel, and convert the receive optical signal into a receive electrical signal;
at least one amplification stage configured to amplify the receive electrical signal; and
a regulated power supply configured to supply electrical power to the photodetector and the amplification stage.

20. The DisplayPort connector of claim 14, wherein the first signal transmitting unit and the first signal receiving unit are commonly connected to the first high-speed DisplayPort electrical interface via a current-mode logic (CML) interface or a voltage-mode logic (VML) interface.

21. The USB/Thunderbolt connector of claim 14, wherein the first signal transmitting unit and the first signal receiving unit are commonly connected to the first high-speed USB/Thunderbolt electrical interface via a high-speed switch.

22. The DisplayPort connector of claim 14, wherein the second signal transmitting unit and the second signal receiving unit are commonly connected to the second high-speed DisplayPort electrical interface via a current-mode logic (CML) interface or a voltage-mode logic (VML) interface.

23. The USB/Thunderbolt connector of claim 14, wherein the second signal transmitting unit and the second signal receiving unit are commonly connected to the second high-speed USB/Thunderbolt electrical interface via a high-speed switch.

24. The DisplayPort connector of claim 14, wherein the first terminal and the second terminal each includes a plurality of pairs of transceiver modules, wherein each transceiver module is comprised of a signal transmitting unit and a signal receiving unit.

25. The DisplayPort connector of claim 24, wherein each transceiver module is a half-duplex transceiver module.

26. The DisplayPort connector of claim 22, wherein the first terminal includes a plurality of DisplayPort signal analysis units, wherein a number of DisplayPort signal analysis units is equal to a number of pairs of transceiver modules.
